(19) United States
(12) Patent Application Publication
(10) Pub. No.: US 2026/0316481 A1
(43) Pub. Date: Oct. 15, 2026

(54) INLAY FOR A CARD OR A DOCUMENT AND METHOD FOR ITS ASSEMBLING

(71) Applicant: ADVANIDE HOLDINGS PTE. LTD., SINGAPORE (SG)

(72) Inventors: Ralf HENN, SINGAPORE (SG); Thanapong PHOTISARN, SINGAPORE (SG); Alejandro PLACITELLI, SINGAPORE (SG)

(21) Appl. No.: 19/481,836

(22) PCT Filed: May 6, 2024
(86) PCT No.: PCT/IB2024/054387

§ 371 Date: Nov. 5, 2025

(30) Foreign Application Priority Data
May 5, 2023 (SG) 10202301254S

(51) Int. Cl. B42D 25/305; B42D 25/351; B42D 25/455; B42D 25/46

(52) U.S. Cl. CPC B42D 25/305; B42D 25/351; B42D 25/455; B42D 25/46

(57) ABSTRACT

An inlay for a card or document comprises a first overlay layer having a pre-fabricated window and a first insert arranged within the pre-fabricated window of the first overlay layer, wherein the insert is configured to prevent distortion of the window during lamination, a core layer, having a first and second side, placed with the first side on the first overlay layer, wherein the core layer comprises a substrate and is configured to accommodate an electronic component, a second overlay layer having a pre-fabricated window, and a second insert arranged within the pre-fabricated window of the second overlay layer, wherein the insert is configured to prevent distortion of the pre-fabricated window during lamination; wherein the second overlay layer is placed on the second side of the core layer, and wherein the first and second overlay layer and the core layer are laminated.

The present application generally relates to an inlay for a card or a document and to a method for its assembling.

EP 3421235 A1 and US2020202080A1 disclose a method of manufacturing cards with a transparent window. A pre-laminating step involves placing a sheet in contact with one or more sides of a laminating plate that features a recess. This sheet is then subjected to lamination, resulting in the formation of a raised portion on the sheet. Following this, during the assembling step, another sheet is positioned in contact with the first sheet, such that the raised portion of the first sheet aligns and fits at least partially into an opening in the second sheet. The process concludes with a laminating step, where the two sheets are laminated together to form the final product.

The object of the application is to provide a durable and secure inlay for cards or documents that accommodates electronic components without distortion during lamination.

The object of the application is solved by the features of the independent claims. Advantageous embodiments of the application are described in the dependent claims.

The application provides solutions for preventing distortion of pre-fabricated windows, ensuring visibility and durability of embedded security features, achieving optimal adhesion and integration of layers, and complying with opacity requirements for consistent visual quality and security standards.

In a first aspect the application refers to elements of an inlay for a card or a document, various advantageous effects can be seen. These elements can be combined with the other elements in the present application as described below.

In this context an inlay for a card or a document may comprise a first overlay layer, a first insert, a core layer, a second overlay layer, a second insert. The first overlay layer may have at least one pre-fabricated window. The first insert can be arranged within the pre-fabricated window of the first overlay layer, wherein the insert is configured to prevent distortion of the window during lamination. The core layer may have a first side and a second side and is placed with the first side on the first overlay layer, wherein the core layer can comprise a substrate and is configured to accommodate at least one electronic component. The second overlay layer may have at least one pre-fabricated window. Further, the second insert can be arranged within the pre-fabricated window of the second overlay layer, wherein the insert may be configured to prevent distortion of the pre-fabricated window during lamination. The second overlay layer can be placed on the second side of the core layer, and wherein the first and second overlay layer and the core layer may be laminated.

The inclusion of pre-fabricated windows with inserts in both the first and second overlay layers ensures the structural integrity of the windows during the lamination process, preventing any undesirable deformation that could impair the visibility or functionality of the card or document. The configuration of the core layer to accommodate at least one electronic component allows for the integration of smart features, such as RFID chips or antennas, thereby enhancing the functionality of the card or document without compromising its physical structure. Laminating the first and second overlay layers with the core layer creates a durable and cohesive structure that protects the embedded electronic components and maintains the card's or document's overall integrity over time. The inlay further provides the advantage of having pre-fabricated windows in the overlay layers, allowing for easy insertion of inserts without the need for additional cutting or shaping.

Furthermore, in a transitional region between the second insert and the second overlay layer, there can be interlacing between the material of the second insert and the material of the second overlay layer providing a hot joining between the second insert and the second overlay layer. The interlacing between the material of the second insert and the second overlay layer provides a robust hot joining that enhances the durability of the window area, ensuring that the insert remains securely in place even under stress or after repeated use. The hot joining minimizes the risk of delamination or separation at the transitional region between the second insert and the second overlay layer, thereby preserving the aesthetic and functional qualities of the card or document.

At least one of the core layers, the first overlay layer, or the second overlay layer may be transparent or opaque. The option for the core layer, the first overlay layer, or the second overlay layer to be transparent or opaque allows for customization of the card or document's appearance and the ability to control the visibility of the internal components or security features. The use of transparent materials can facilitate the integration of see-through windows or areas for displaying information, while opaque materials can be used to conceal sensitive components, providing a balance between functionality and security. The versatility in transparency and opacity provides manufacturers with the flexibility to design cards or documents that meet specific requirements for a wide range of applications, from identification cards to secure access badges.

The substrate of the core layer may comprise a PC film, a PVC film, or a PETG film. The use of a PC film, PVC film, or PETG film as a substrate for the core layer offers a selection of materials with varying properties, such as heat resistance and impact strength, allowing for the tailoring of the card's or document's physical properties to the intended use environment. These materials are known for their durability and resistance to wear and tear, which contributes to the longevity of the card or document, reducing the need for frequent replacements and thereby offering cost savings over time. The selection of these films can also influence the card's or document's flexibility and rigidity, enabling the creation of products that meet specific handling and usage requirements, such as flexibility for wallet storage or rigidity for insertion into readers.

Further, the first overlay layer and/or the second overlay layer may comprise a PC film, a PVC film, or a PETG film. The choice of a PC film, PVC film, or PETG film for the first and/or second overlay layers provides a harmonious match with the core layer substrate when the same material is used, resulting in uniform thermal expansion properties and improved lamination quality. These films offer excellent printability and adhesion characteristics, which are essential for the application of high-resolution graphics, text, and security features on the card or document surfaces. The use of these materials in the overlay layers can enhance the card's or document's resistance to environmental factors such as UV light, moisture, and chemicals, ensuring that the printed information and embedded features remain intact throughout the product's lifespan.

The insert may comprise a PC film, a PVC film, or a PETG film. The inclusion of an insert made from materials such as PC film, PVC film, or PETG film enhances the durability of the inlay, providing resistance to environmental factors such as moisture, temperature fluctuations, and physical abrasion. Utilizing these types of films can improve the structural integrity of the inlay, ensuring that it maintains its shape and functionality over an extended period of use. The films can be selected based on their specific properties, such as flexibility or rigidity, to tailor the inlay to the requirements of various applications, thereby increasing the versatility of the inlay's use in different products.

The insert may comprise an optical variable material configured to provide a security feature. Incorporating an optical variable material as an insert provides a dynamic security feature that is difficult to replicate, thereby enhancing the anti-counterfeiting measures of the product. The security feature provided by the optical variable material can be easily verified by visual inspection, facilitating quick authentication without the need for specialized equipment. The aesthetic appeal of the optical variable material can also serve as a distinctive branding element, contributing to the product's market differentiation and consumer appeal.

The core layer may comprise an optical variable material configured to provide a security feature. Embedding an optical variable material within the core layer of the inlay ensures that the security feature is integral to the inlay structure, making it less susceptible to tampering or removal. The core layer configuration protects the optical variable material from surface wear and environmental damage, preserving the security feature's effectiveness over the product's lifespan. The integration of the security feature within the core layer allows for a seamless design that does not interfere with the overall thickness or flexibility of the inlay, maintaining its compatibility with a wide range of applications.

The first opaque overlay layer and the second opaque overlay layer may comprise layer a high-opaque material configured to cover visibility of the electronic component. The use of a high-opaque material layer effectively conceals the electronic components within the inlay, preventing visual detection and potential tampering or reverse engineering. By obscuring the internal components, the high-opaque material layer adds an additional layer of security, protecting sensitive information that may be stored or transmitted by the electronic component. The high-opacity layer can also enhance the aesthetic design of the inlay by providing a uniform appearance that can be customized with branding or informational graphics without revealing the underlying technology.

The transparent inserts can be made from an optical variable material, providing unique characteristics such as color shift, UV strong fluorescence, and other security features. Transparent inserts made from an optical variable material allow for the creation of unique visual effects, such as color shifts and UV fluorescence, which serve as both a security feature and a design element. The use of optical variable materials in transparent inserts enables the inlay to maintain a high level of security without compromising the design or visibility of other inlay components, such as printed information or branding. The unique characteristics provided by the optical variable material can be tailored to specific wavelengths or viewing angles, offering a customizable security solution that can be adapted to the needs of different industries and applications.

The optical variable material further may comprise a holographic or diffractive pattern. The incorporation of an optical variable material with a holographic or diffractive pattern enhances the security features of the inlay, making it more resistant to counterfeiting and unauthorized reproduction. The holographic or diffractive pattern provides a visually distinctive appearance that can be easily recognized by individuals, thereby facilitating the quick authentication of the inlay without the need for specialized equipment.

The core layer may further comprise a lower transparent core layer, an upper transparent core layer and a height adjustment transparent core layer. The lower transparent core layer is in contact with a side of the first overlay layer. The upper transparent core layer is on top of the lower transparent core layer, wherein the upper transparent core layer comprises at least one layer. The height adjustment transparent core layer is on top of the at least one upper transparent core layer. The presence of a lower transparent core layer in direct contact with the first overlay layer provides structural integrity and protection to the underlying features, thereby enhancing the durability of the inlay. The addition of an upper transparent core layer consisting of at least one layer allows for the customization of the inlay's thickness and rigidity, which can be tailored to specific application requirements. The height adjustment transparent core layer enables precise control over the overall thickness of the inlay, ensuring compatibility with a variety of devices and housings while maintaining the desired level of transparency.

The inlay may comprise a third layer on the side of the first and second overlay layer opposite to the core layer. The inclusion of a third layer on the opposite side of the first and second overlay layers serves to protect the core layer from environmental damage and physical wear, thereby extending the lifespan of the inlay. The third layer can be engineered to provide additional functionalities, such as improved adhesion to external surfaces or enhanced resistance to tampering, further increasing the utility of the inlay.

The inlay may comprise a fourth layer on the side of the third layer opposite to the first and second overlay layer. The fourth layer adds an extra level of protection and can be used to incorporate additional security features or aesthetic elements, which can enhance the overall value and appeal of the inlay. The presence of the fourth layer on the side of the third layer opposite to the first and second overlay layers can provide a balanced structure, which may improve the handling and processing of the inlay during manufacturing and integration into final products.

The electronic component may comprise a chip module and an embedded antenna. The integration of an electronic component comprising a chip module and an embedded antenna enables the inlay to support electronic communication and data storage capabilities, which can be used for advanced authentication, tracking, and data exchange applications. The embedded antenna ensures that the electronic component maintains a low profile within the inlay, preserving the inlay's physical flexibility and aesthetic appearance while providing reliable wireless connectivity.

The chip module can be a contactless chip module. The integration of a contactless chip module within the inlay enables secure and rapid wireless communication, facilitating transactions and data exchange without the need for physical contact. The presence of a contactless chip module enhances user convenience by allowing for seamless integration with contactless readers, thereby improving the user experience in various applications such as access control, payment systems, and identification.

The embedded antenna can be integrated into the core layer using wire embedding, printing, or etching. Embedding the antenna into the core layer using techniques such as wire embedding, printing, or etching allows for a compact and robust design, reducing the overall thickness and improving the durability of the inlay. The integration of the antenna through these methods can lead to improved signal performance and reliability, ensuring consistent communication with contactless readers even in challenging environmental conditions.

The pre-fabricated windows in the first and second first overlay layer may have a minimum size of 5.0×5.0 mm with a tolerance of 10% to ensure compliance with specified security feature dimensions. The specification of a minimum size for the layer ensures that the inlay has sufficient structural stability to withstand handling and environmental stresses, thereby extending the lifespan of the product. By defining a minimum size for the layer, the inlay can be designed to meet specific performance criteria, such as mechanical strength and flexibility, which are critical for certain applications like identification cards or passports.

Each pre-fabricated window in the first and second first overlay layer includes corners with a minimum radius greater than 0.2 mm to reduce stress concentrations and enhance the structural integrity of the inlays. The inclusion of pre-fabricated windows with corners having a minimum radius greater than mm reduces stress concentrations, which can significantly enhance the structural integrity of the inlays and prevent cracking or breaking at the corners. The design consideration for corner radii also contributes to improved safety by eliminating sharp edges, thereby reducing the risk of injury to users during handling and use of the inlay-containing products.

Any line or pole in the design of the pre-fabricated window may have a width greater than 2.0 mm to ensure sufficient visibility and durability of the embedded security features. Ensuring that any line or pole in the design of the pre-fabricated window has a width greater than 0 mm guarantees the visibility and legibility of embedded security features, which is crucial for verification and authentication purposes. The specification of a minimum width for lines or poles contributes to the durability of the design elements, protecting against wear and tear that could otherwise compromise the security features over time.

The inserts placed within the pre-fabricated windows may have a thickness on one side of at least 30 μm, and preferably 50 μm, to match the opacity requirements of the first and second overlay layer, thereby ensuring consistent visual quality and security standard compliance. The specified minimum thickness of the windows ensures that the inlay meets certain opacity standards, which is critical for maintaining a uniform appearance across the card, thus enhancing the aesthetic appeal and professional presentation of the chip card. By matching the opacity requirements of the overlay layers, the inlay contributes to the card's security features, as consistent visual quality can help prevent tampering and counterfeiting, thereby offering a higher level of protection for sensitive information.

Hot lamination may be performed at approximately 175 °C for 15 minutes to achieve optimal adhesion and integration of the layers without compromising the material integrity of the inlays. The precise control of the lamination temperature and duration ensures that the layers of the inlay are securely bonded, which enhances the durability and longevity of the chip card by preventing delamination and wear over time. By optimizing the lamination process, the integrity of the materials is preserved, which means that the inlay can maintain its functionality and reliability even under the stress of regular use, thus providing a dependable platform for secure transactions.

Furthermore, a chip card is provided. The chipcard may comprise an inlay according to the embodiment described above. The integration of the inlay as disclosed provides a foundation for the chip card that is designed to meet specific performance criteria, ensuring that the card operates effectively in a wide range of transactional environments. The use of an inlay according to the disclosed application allows for the creation of a chip card that can be tailored to meet the evolving standards of the payment industry, offering flexibility in design and the potential for future enhancements.

Additionally, the application relates to a method for assembling an inlay. The method may comprise the steps of providing a first overlay layer, wherein the first overlay layer has at least one pre-fabricated window, and of arranging a first insert within the pre-fabricated window of the first overlay layer, wherein the insert is configured to prevent distortion of the window during lamination. Further, the method may comprise the steps of placing a core layer, having a first side and a second side, with the first side on the first overlay layer, wherein the core layer comprises a substrate and is configured to accommodate at least one electronic component, and of providing a second overlay layer, wherein the second overlay layer having at least one pre-fabricated window. Also, the method may comprise the steps of arranging a second insert within the pre-fabricated window of the second overlay layer, wherein the insert is configured to prevent distortion of the pre-fabricated window during lamination, and of placing the second overlay layer on the second side of the core layer, and of laminating the first and second overlay layer and the core layer to assemble the inlay.

The method steps outlined can lead to improved manufacturing processes, resulting in a more efficient production of chip cards with potentially lower defect rates and higher yield. By further refining the method of producing the inlay, the resulting chip cards can exhibit enhanced performance characteristics, such as better electrical connectivity or improved structural integrity, which can translate to a better user experience.

The method may further comprise the steps of integrating an electronic component within the core layer, wherein in a transitional region between the first insert and the first overlay layer, there is interlacing between the material of the first insert and the material of the first overlay layer, providing a hot joining between the first insert and the first overlay layer, by submitting both the insert and the overlay layer to heat such that they both melt and their molten materials penetrate into each other and then lock mechanically to each other after hardening, without adding additional glue materials into the joint between the insert and the first overlay layer. The inclusion of an additional layer as part of the method can provide added functionality or protection to the chip card, such as increased resistance to environmental factors or additional security features. The extra layer can be engineered to introduce new properties to the chip card, such as improved tactile feedback or visual elements, which can serve to differentiate the card in the marketplace and add value for the end user.

The inlay can be assembled in an inlay sheet consisting of a plurality of single inlays, wherein the method further comprises, extracting a single inlay from the inlay sheet by using cutting technique. The assembly of inlays into an inlay sheet streamlines the manufacturing process by allowing multiple inlays to be handled simultaneously, improving throughput and reducing labor costs. The ability to extract single inlays from the inlay sheet using a cutting technique provides a precise and clean method for individual inlay separation, enhancing the quality of the final product. This method of extraction reduces material waste by allowing for the precise removal of inlays from the sheet, contributing to cost savings and environmental sustainability.

The skilled person will recognize that the advantages, technical effects and preferred embodiments discussed in connection with the inlay apply analogously to the method for assembling an inlay. Likewise, all the advantages, technical effects and preferred embodiments described in connection with the method are transferable to the inlay.

In further aspects that refer to elements of a multilayered inlay composition and features, various advantageous effects can be seen. These elements can be combined with the other elements in the present application as described above and below.

In this respect, a multilayered inlay may comprise a plurality of layers, at least one core layer and a plurality of inserts. The plurality of layers can be arranged in any combination and permutation of: a first and a second overlay layer, wherein the first and second layer having at least one pre-fabricated window. The at least one core layer can be placed between the first and second overlay layer. The plurality of inserts can be arranged within the pre-fabricated window of the first and second overlay layer, wherein the insert is configured to prevent distortion of the window during lamination.

The provision of pre-fabricated windows in both the first and second overlay layers allows for precise alignment of the inserts, ensuring consistent quality and appearance of the final product. The configuration of the inserts to prevent distortion during lamination enhances the structural integrity of the inlay, maintaining the desired flatness and uniformity across the layers. The multilayered structure with the core layer placed between the overlay layers provides additional strength and durability to the inlay, potentially extending its lifespan and usability in various applications.

The first and the second overlay layer may comprise optical variable materials, OVM-layer, or white/opaque layers and the core layer may comprise a transparent core layer/layers or an OVM-layer/layers. The inserts may also comprise OVM.

The arrangement of said layers and inserts can be configured to provide enhanced security features, visual effects, or electronic functionality, and each layer and insert may be bonded using a lamination process that maintains the integrity and alignment of each layer and insert despite the differing material properties.

The arrangement of a plurality of inserts within the pre-fabricated windows contributes to the overall robustness of the inlay, as it can better withstand external pressures and resist deformation. The specific configuration of the inserts to counteract distortion during the lamination process ensures that the windows retain their shape and size, which is critical for applications where dimensional accuracy is paramount. The multilayered inlay design allows for customization and versatility in use, as different materials and properties can be incorporated into the core and overlay layers to meet specific requirements of different industries or products.

In further aspects that refer to elements of a method for assembling multi-layer inlays with embedded inserts, various advantageous effects can be seen. These elements can be combined with the other elements in the present application as described above and below.

In this context, a method for assembling a multi-layer inlay with embedded inserts is provided. The method may comprise the method steps of providing a first and second overlay layer having at least one pre-fabricated window, of utilizing a pick-and-place machine to precisely position inserts within said pre-fabricated window, and of employing a microbonding technique to securely bond the positioned inserts within the pre-fabricated window.

The utilization of a pick-and-place machine for positioning inserts ensures high precision and repeatability in the assembly process, leading to consistent quality of the multi-layer inlays. Employing a microbonding technique to bond the inserts within the pre-fabricated windows allows for a strong and durable connection without significantly increasing the thickness or altering the structural integrity of the inlay layers. The method enables the efficient assembly of complex inlays with embedded inserts, potentially reducing manufacturing time and costs associated with manual positioning and bonding processes.

The microbonding may involve the step of applying localized heat and pressure to create a durable bond without damaging the surrounding materials or the inserts. Each insert may comprise optical variable materials.

The inclusion of inserts comprising optical variable materials enhances the security features of the multi-layer inlay, making it more difficult to counterfeit and thus providing added value in applications such as identity documents and currency. The optical variable materials can provide unique visual effects that can be easily authenticated by individuals without the need for specialized equipment, increasing the practicality of the security feature. The use of optical variable materials in the inserts allows for customization of the inlay's appearance, offering the possibility to create distinctive and aesthetically appealing designs that can serve both security and branding purposes.

In further aspects that refer to elements of a configuration and features of multi-layered inlays with electronic modules, various advantageous effects can be seen. These elements can be combined with the other elements in the present application as described above and below.

A multi-layered inlay may comprise at least one first overlay layer, at least a first insert and traces and/or wires for connecting electronic modules. The at least one first overlay layer may have at least one pre-fabricated window. The at least a first insert may be within the pre-fabricated window of the first overlay layer and the insert can be configured to prevent distortion of the window during lamination. Further, the traces and/or wires for connecting electronic modules may be configured within a core layer. The core layer can be placed next to the first overlay layer, and the wires may be positioned to be visible through the window or window including the insert.

The inclusion of a pre-fabricated window in the first overlay layer ensures precise alignment with the underlying electronic modules, thereby facilitating accurate visual access to the components beneath. The insert within the pre-fabricated window serves to maintain the structural integrity of the window during the lamination process, preventing deformation that could obscure the visibility of the electronic modules. By allowing the traces and/or wires to be visible through the window or window with the insert, the design enables easy inspection and verification of the circuitry without the need for disassembly or additional inspection tools.

The visibility of the antenna traces or wires through the window or the window including the insert provides at least one of the following: Enhancing the aesthetic appearance of the device; Providing visual verification of the electronic module presence and integrity; acting as a security feature by incorporating specific visible patterns or configurations that are difficult to replicate without proper manufacturing capabilities.

The electronic modules may comprise an antenna and/or a chip module.

The insert's ability to enhance the aesthetic appearance of the device allows for customization and branding opportunities, enabling manufacturers to differentiate their products in the market with visually appealing designs that can be tailored to specific customer preferences or corporate identities. Providing visual verification of the electronic module's presence and integrity through the insert not only simplifies quality control processes but also instills confidence in end-users regarding the authenticity and proper functioning of the device, potentially reducing the incidence of counterfeit products. The insert acting as a security feature by incorporating specific visible patterns or configurations adds an additional layer of protection against unauthorized replication, as these unique designs require specialized manufacturing techniques that are not easily accessible to counterfeiters, thereby enhancing the overall security of the device

In further aspects that refer to elements of a method for bonding an insert to a first overlay layer, various advantageous effects can be seen. These elements can be combined with the other elements in the present application as described above and below.

In this regard, a method for bonding an insert to a first overlay layer is provided. The method may comprise the method steps of aligning the insert with at least one first overlay layer, wherein at least one of the inserts and the first overlay layer comprises a fusible material, of applying heat and pressure to the aligned insert and first overlay layer to induce fusion between the materials of the insert and the first overlay layer, and of controlling the heat and pressure application to form material cohesive undercuts within the fused area of the insert and/or first overlay layer, wherein the undercuts interlock to enhance the mechanical bonding strength.

The method enhances the durability of the bonded assembly by creating material cohesive undercuts that interlock, providing a mechanical bond that is inherently stronger than a bond formed by surface adhesion alone. By utilizing the fusible material properties of either the insert or the overlay layer, the need for additional bonding agents is eliminated, simplifying the manufacturing process and reducing material costs. The controlled application of heat and pressure allows for precise manipulation of the bonding environment, ensuring consistent quality of the bond across multiple assemblies and reducing the likelihood of manufacturing defects.

No additional adhesive may be used in the bonding process, and the bonding can achieve structural integrity through the material cohesion and undercut formation.

The elimination of additional adhesives in the bonding process reduces the potential for chemical incompatibility between the adhesive and the materials being bonded, thereby enhancing the long-term stability and reliability of the product. The method promotes environmental sustainability by reducing the use of potentially hazardous adhesives and by simplifying the recycling process, as the bonded components can be more easily separated without adhesive residues. The bonding process achieves structural integrity through material cohesion and undercut formation, which can result in a lighter-weight product as the absence of additional adhesives can contribute to a reduction in overall material usage.

In further aspects that refer to elements of a method for manufacturing a laminated device, various advantageous effects can be seen. These elements can be combined with the other elements in the present application as described above and below.

A method for manufacturing a laminated device may comprise the steps of performing a first lamination cycle on a multi-layer assembly comprising multiple layers bonded under heat and pressure; and of immediately following the first lamination cycle, initiating an active cooling process. The immediate initiation of an active cooling process following the first lamination cycle minimizes the thermal exposure of the multi-layer assembly, thereby reducing the risk of thermal degradation of the materials. By transitioning directly from the lamination to the cooling phase, the method potentially shortens the overall manufacturing time, leading to increased throughput and productivity. The rapid commencement of cooling after lamination may enhance the bond strength between layers by preventing the relaxation of adhesive materials while still in a heated state, resulting in a more durable laminated device.

The method may further comprise the step of controlling the active cooling process to rapidly reduce the temperature of the multi-layer assembly to a predetermined level effective to stabilize the materials and solidify the bonds formed during the first lamination cycle. The active cooling may involve applying a cooling medium directly to the surfaces of the multi-layer assembly or circulating the cooling medium within a chamber containing the assembly. Furthermore the method may comprise the step of monitoring the temperature of the multi-layer assembly during the active cooling process using temperature sensors, and adjusting the cooling rate based on real-time temperature data to prevent material distortion and enhance the structural integrity of the laminated product.

Controlling the active cooling process to rapidly reduce the temperature to a predetermined level allows for precise material stabilization, ensuring consistent quality and performance of the laminated device. The application of a cooling medium directly to the surfaces of the multi-layer assembly or the circulation within a chamber provides uniform cooling, which is critical for maintaining dimensional accuracy and preventing warping or other forms of distortion. Real-time temperature monitoring and adjustable cooling rates based on this data enable the optimization of the cooling process for different materials and assembly configurations, thus enhancing the structural integrity and reliability of the final product.

In further aspects that refer to elements of a method for manufacturing a chip card from an inlay sheet comprising a plurality of assembled inlays, various advantageous effects can be seen. These elements can be combined with the other elements in the present application as described above and below.

A method for manufacturing a chip card from an inlay sheet comprising a plurality of assembled inlays may comprise the method step of providing an inlay sheet containing a plurality of assembled inlays pre-arranged in defined card areas; and of utilizing a punching mechanism to cut a chip card from the inlay sheet, where each defined card area corresponds to the dimensions and shape of the finished chip card.

The provision of an inlay sheet containing a plurality of assembled inlays pre-arranged in defined card areas streamlines the manufacturing process by enabling simultaneous preparation of multiple chip cards, thereby enhancing production efficiency. By pre-arranging the inlays within the inlay sheet to correspond to the dimensions and shape of the finished chip cards, the method ensures precision and uniformity in the final product, reducing the likelihood of errors and material waste. The utilization of a punching mechanism to cut a chip card from the inlay sheet allows for a clean and precise separation of individual cards, which can lead to a higher quality edge finish and a more aesthetically pleasing final product.

The present disclosure is illustrated by way of example and not limited in the accompanying figures in which like reference numerals indicate similar elements. Embodiments of the application will now be described with reference to the attached drawings:

A further embodiment combines one or more elements of the aspect relating to the inlay for a card or a document with one or more elements of the aspect relating to the multilayered inlay composition and features.

A further embodiment combines one or more elements of the aspect relating to the inlay for a card or a document with one or more elements of the aspect relating to the method for assembling multi-layer inlays with embedded inserts.

A further embodiment combines one or more elements of the aspect relating to the inlay for a card or a document with one or more elements of the aspect relating to the configuration and features of multi-layered inlays with electronic modules.

A further embodiment combines one or more elements of the aspect relating to the inlay for a card or a document with one or more elements of the aspect relating to the method for bonding an insert to a first overlay layer.

A further embodiment combines one or more elements of the aspect relating to the inlay for a card or a document with one or more elements of the aspect relating to the method for manufacturing a laminated device.

A further embodiment combines one or more elements of the aspect relating to the inlay for a card or a document with one or more elements of the aspect relating to the method for manufacturing a chip card from an inlay sheet comprising a plurality of assembled inlays.

A further embodiment combines one or more elements of the aspect relating to the multilayered inlay composition and features with one or more elements of the aspect relating to the method for assembling multi-layer inlays with embedded inserts.

A further embodiment combines one or more elements of the aspect relating to the multilayered inlay composition and features with one or more elements of the aspect relating to the configuration and features of multi-layered inlays with electronic modules.

A further embodiment combines one or more elements of the aspect relating to the multilayered inlay composition and features with one or more elements of the aspect relating to the method for bonding an insert to a first overlay layer.

A further embodiment combines one or more elements of the aspect relating to the multilayered inlay composition and features with one or more elements of the aspect relating to the method for manufacturing a laminated device.

A further embodiment combines one or more elements of the aspect relating to the multilayered inlay composition and features with one or more elements of the aspect relating to the method for manufacturing a chip card from an inlay sheet comprising a plurality of assembled inlays.

A further embodiment combines one or more elements of the aspect relating to the method for assembling multi-layer inlays with embedded inserts with one or more elements of the aspect relating to the configuration and features of multi-layered inlays with electronic modules.

A further embodiment combines one or more elements of the aspect relating to the method for assembling multi-layer inlays with embedded inserts with one or more elements of the aspect relating to the method for bonding an insert to a first overlay layer.

A further embodiment combines one or more elements of the aspect relating to the method for assembling multi-layer inlays with embedded inserts with one or more elements of the aspect relating to the method for manufacturing a laminated device.

A further embodiment combines one or more elements of the aspect relating to the method for assembling multi-layer inlays with embedded inserts with one or more elements of the aspect relating to the method for manufacturing a chip card from an inlay sheet comprising a plurality of assembled inlays.

A further embodiment combines one or more elements of the aspect relating to the configuration and features of multi-layered inlays with electronic modules with one or more elements of the aspect relating to the method for bonding an insert to a first overlay layer.

A further embodiment combines one or more elements of the aspect relating to the configuration and features of multi-layered inlays with electronic modules with one or more elements of the aspect relating to the method for manufacturing a laminated device.

A further embodiment combines one or more elements of the aspect relating to the configuration and features of multi-layered inlays with electronic modules with one or more elements of the aspect relating to the method for manufacturing a chip card from an inlay sheet comprising a plurality of assembled inlays.

A further embodiment combines one or more elements of the aspect relating to the method for bonding an insert to a first overlay layer with one or more elements of the aspect relating to the method for manufacturing a laminated device.

A further embodiment combines one or more elements of the aspect relating to the method for bonding an insert to a first overlay layer with one or more elements of the aspect relating to the method for manufacturing a chip card from an inlay sheet comprising a plurality of assembled inlays.

A further embodiment combines one or more elements of the aspect relating to the method for manufacturing a laminated device with one or more elements of the aspect relating to the method for manufacturing a chip card from an inlay sheet comprising a plurality of assembled inlays.

### SHORT DESCRIPTION OF THE FIGURES

FIG. 1 shows a cross-sectional view of an inlay according to the application with arrows symbolizing the material flow during hot lamination,

FIG. 2 shows what happens when a lamination step takes place in the inlay of FIG. 1 and material from the transparent core layer flew into the windows 6,

FIG. 3 shows a top view of the inlet according to the FIG. 2 with transparent window 6 shape after lamination, without an insert 3 according to the application,

FIG. 4 shows a cross-sectional view of an inlay according to a further embodiment of the application with arrows symbolizing the flowing behavior of material comparing between with vs without inserts 3,

FIG. 5 shows an inlay design according to a further embodiment of the application with transparent windows 6,

FIG. 6 shows a cross-sectional view of an inlay design according to a further embodiment of the application with pre-cut windows 6 or voids,

FIG. 7 shows a cross-sectional view of an inlay construction according to a further embodiment of the application with inserts 3 filling the windows 6,

FIG. 8 shows a cross-sectional view of an inlay design according to a further embodiment of the application with high opaque overlay,

FIG. 9 shows a cross-sectional view of an inlay design according to a further embodiment of the application with optical variable material inserts 3 added to the windows 6,

FIG. 10 shows a cross-sectional view of an inlay design according to a further embodiment of the application with an optical variable material core layer,

FIG. 11 shows a cross-sectional view of an inlay design according to a further embodiment of the application with transparent windows 6 and a chip module 4,

FIG. 12 shows a cross-sectional view of an inlay design according to the application with pre-cut windows 6,

FIG. 13 shows an inlay design of FIG. 12 according to a further embodiment of the application, where the pre-cut windows or voids are placed with inserts 3 fillings,

FIG. 14 shows a top view of an interaction area between the inlet 3 and the opaque layer in an inlay design according to the application,

FIG. 15 shows the composition of an inlay design according to a further embodiment of the application,

FIG. 16 shows the detailed composition of the inlay design of FIG. 15, and

FIG. 17 shows a cross section of an inlay design according to a further embodiment of the application including layers above the top opaque layers.

The present disclosure is illustrated by way of example and not limited in the accompanying figures in which like reference numerals indicate similar elements. Embodiments of the application will now be described with reference to the attached drawings

The application describes product design and processes of how the transparent window 6 feature can be created and incorporated into inlays 7 in a better appearance. The feature will then be used for displaying security elements that are embedded in chip cards 8 that are made with the inlay 7 according to the application.

### DETAILED DESCRIPTION

An inlay 7 with transparent windows 6 comprises the inserts 3 and multi-layered substrates such as PC. The core layer 1 or core layers 1 are transparent, where copper wire antennas and chip 11 modules are embedded and covered by white or opaque overlays 9 or overlay layers 10 on both top and bottom.

The application takes advantage of the opaque overlays 9 to create white plain inlay 7 surface, this would also cover visibility of wire-embedded antennas and chip 11 modules. With the pre-punched windows 6 in specific area on both sides of opaque overlays 9, it creates see-through function on inlays 7. The inserts 3 are used to fill in the gaps, keeping control of the windows 6 shape and their size to remain in defined dimensions.

The application aims at the following matters:
1. How to create a transparent windows 6 feature at inlays 7 and
2. How to control transparent windows 6 shrinkage.

The transparent windows 6 of the application are built into the chip cards 8 during cards 8 production. The process is easy. One way to achieve this is already integrate into inlays 7 prior to making cards 8, using these inlays 7. The feature can be developed and incorporated into inlays 7.

Basically, the transparent windows 6 can be simply created by having pre-punched windows 6 on the opaque overlays 9. But with this current method, there is always a difficulty to keep control of window 6 shrinkage after lamination, as the consequence the size and shape of the windows 6 will alter and not in accordance with the defined dimensions anymore.

Therefore the application will not only aim to offer inlay 7 solution with transparent windows 6 feature but will also incorporate an enhanced and industrialized methods to better keep the windows 6 within the defined shape and dimensions by using the inserts 3 to fill in the gap.

The inserts 3 will function as a brick, preventing the core layers 1 and overlay layers 10 from freely and uncontrollably flowing into the gaps when being melted, causing a distortion of the transparent windows 6.

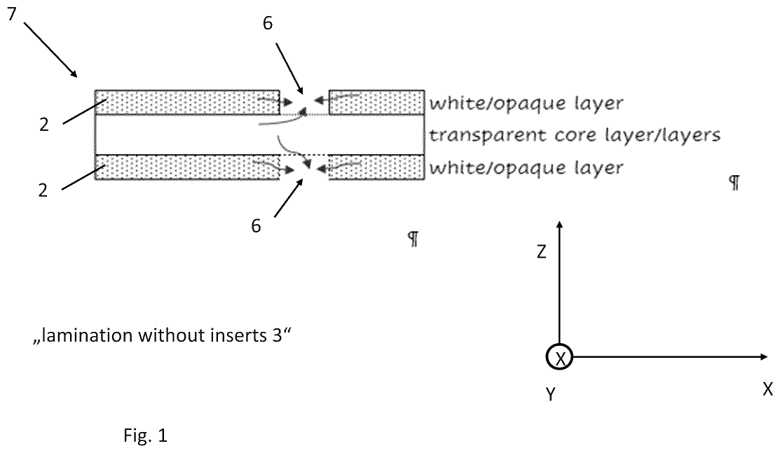

FIG. 1 presents a cross-sectional view of a multi-layer assembly 7 (inlay 60) utilized in the lamination process, notably devoid of inserts 3. This assembly comprises two white/opaque layers 2 (also referred to as the first overlay layer 2 and second overlay layer 2) enveloping a central transparent core layer 1. Integrated within the white/opaque layers 2 are two transparent windows 6, indicated by arrows, crucial for the assembly process without the inclusion of inserts 3. The configuration depicted ensures the integrity of the lamination and the clarity of the transparent windows 6 throughout the process.

The multi-layered inlay 60 specify that the first and second overlay layers 2, 10 each have at least one pre-fabricated window 6. Although FIG. 1 does not explicitly show inserts 3, it demonstrates the potential for accommodating such inserts to prevent distortion during lamination, aligning with the detailed steps in the method 100 for assembling an inlay 7.

Electronic modules such as an antenna 5 and/or a chip module 4, as described in the multi-layered inlay 60 claims, are intended to be configured within the core layer 1. While these modules are not explicitly visible in FIG. 1, the setup indicates their potential placement and visibility through the transparent windows 6, which can enhance the aesthetic appeal, provide visual verification of electronic module presence and integrity, and act as a security feature by incorporating specific visible patterns.

Additionally, method 500 for manufacturing a chip card 8 from an inlay sheet 16 involves providing a sheet containing pre-arranged assembled inlays 7, 60 and using a punching mechanism to cut individual chip cards 8. While FIG. 1 does not specifically illustrate the punching process, the arrangement and layer composition serve as a foundational structure potentially suitable for further processing into defined card areas, aligning with the dimensions and shapes of finished chip cards 8 as specified in method 500.

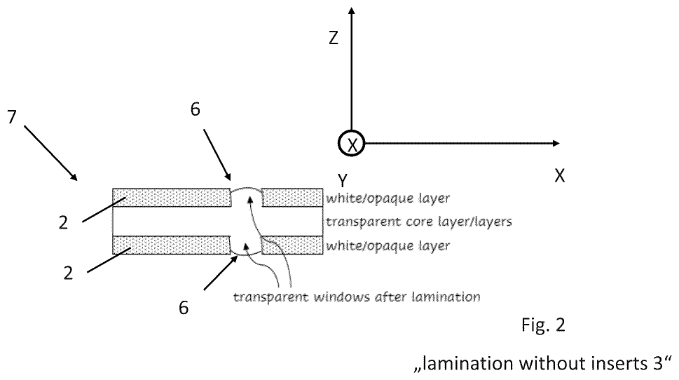

FIG. 2 depicts a cross-sectional view of a laminated structure following the lamination process. The structure comprises two white/opaque layers 2 (also identified as the first and second overlay layers 2, 10) surrounding a central transparent core layer 1. Notably, the FIG. 2 shows transparent windows 6 that have been preserved post-lamination, demonstrating the lamination process without inserts 3. This structure exemplifies a clear visual pathway through the transparent windows 6, which can be crucial for aesthetic and verification purposes as outlined in the claims.

According to the multi-layered inlay 60 claims, this assembly configuration with the first and second overlay layers 2, 10, each having at least one pre-fabricated window 6, is ideal for enhancing the aesthetic appearance of the inlay, providing visual verification of embedded electronic modules, and incorporating specific visible security features. These claims highlight the importance of the transparency and clarity of the windows 6 post-lamination, which FIG. 2 aptly demonstrates, even in the absence of inserts 3 typically used to prevent window distortion. The multi-layered inlay 60 specifies that the first and second overlay layers 2, 10 should each have at least one pre-fabricated window 6. The structure shown in FIG. 2, with its well-preserved transparent windows 6 post-lamination, aligns with the claims' requirements, including the absence of inserts 3, which are typically used to prevent distortion of the windows 6 during lamination.

The visibility of potential electronic modules such as antenna traces or wires configured within the core layer 1, which would be visible through the transparent windows 6, relates directly to the claims. These features enhance the aesthetic appearance of the device, provide visual verification of the electronic module's presence and integrity, and act as a security feature through specific visible patterns that are difficult to replicate.

The method 100 for assembling an inlay 7, 60 describes a process involving the provision of overlay layers 2, 10 with pre-fabricated windows 6, and placement of a core layer 1 in between these layers, configured to accommodate electronic components 4, 5. While FIG. 2 does not depict the electronic components directly, the layer setup is indicative of a configuration that could support such components, aligning with the functional requirements of accommodating and visually verifying these components.

Additionally, the arrangement supports the multi-layered inlay 60 framework by potentially enhancing the inlay's visual and functional attributes, making it not only a component of the finished product but also integral to its manufacturing process as outlined in method 100.

FIG. 2 serves as an illustration of how the described multi-layer assembly can be effectively implemented in accordance with the stipulated claims, demonstrating the post-lamination integrity of the transparent windows 6 and their potential roles in both aesthetic and functional aspects of the final product. The depicted structure in FIG. 2 exemplifies the essential attributes of a multi-layered inlay 60 and inlay 7 as described in the claims, showcasing how the lamination process preserves the critical features necessary for functional and aesthetic purposes in the final product.

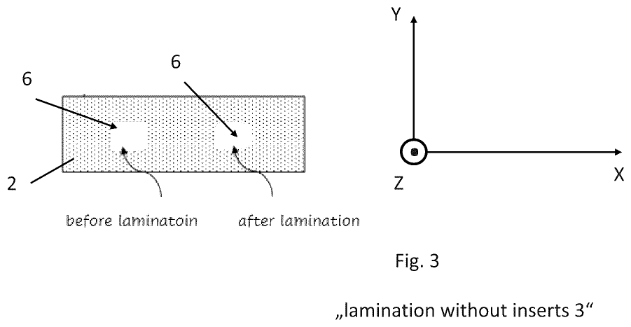

FIG. 3 provides a clear before-and-after perspective on the lamination process within a multi-layer structure, as for instance shown in FIG. 1 and FIG. 2, emphasizing the transition of transparent windows 6 within a white/opaque layer 2. This illustration is pivotal in demonstrating how the lamination process adeptly preserves the structural and aesthetic integrity required for advanced security features and compliance with precise manufacturing specifications.

In the depicted lamination process, the white/opaque layers 2, identified as both the first and second overlay layers 2, 10, encapsulate a series of pre-fabricated windows 6. The method 100 ensures that these windows 6 are designed with specific dimensions (minimum of 5.0×5.0 mm with a 10% tolerance) and corner radii (greater than 0.2 mm), critical for reducing stress concentrations and enhancing the structural integrity of the inlays. This strategic design is essential not only for maintaining the physical dimensions through the lamination process but also for ensuring that the inlays meet rigorous security and durability standards. These windows are also designed to feature lines or poles with a width greater than 2.0 mm to ensure that any embedded security features remain visible and durable after lamination, a factor that enhances both the practical and security aspects of the multi-layered inlay 60.

Moreover, the configuration of FIG. 3 aligns seamlessly with the objectives of method 200, which involves the precise positioning of inserts 3 within these pre-fabricated windows 6 using advanced pick-and-place machinery, followed by a microbonding technique that securely bonds these inserts without compromising the surrounding materials. The integrity of the windows 6 post-lamination in FIG. 3 suggests that the lamination process itself supports the structural prerequisites necessary for the subsequent embedding of security features that are visually verifiable and difficult to replicate, enhancing both the aesthetic appeal and the security functionality of the end product.

This comprehensive demonstration in FIG. 3 not only highlights the technical prowess in maintaining critical manufacturing standards but also illustrates the integral role of lamination in ensuring the functionality and compliance of the multi-layered inlay 60 with security features as stipulated in the patent claims.

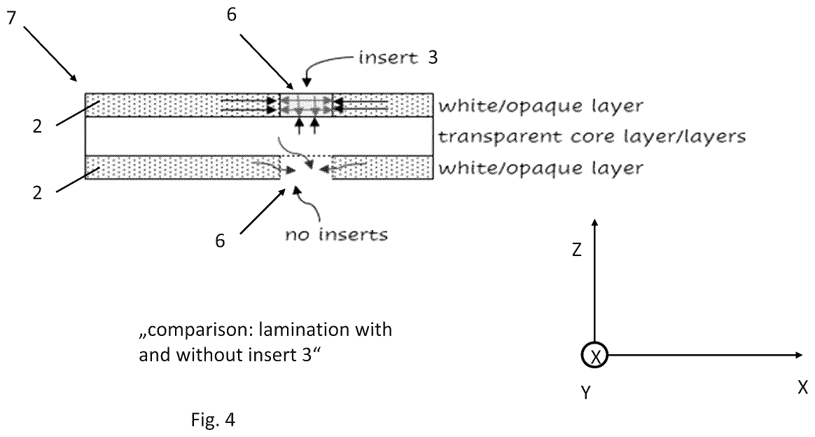

FIG. 4 illustrates a cross-sectional view of a laminated multi-layer structure 7, showcasing a comparison between sections with and without an insert 3 within the lamination process. This figure provides an insightful visual representation of the structural variations and the impact of insert inclusion on the integrity and functionality of the layered assembly.

The structure comprises a sandwich configuration with white/opaque layers 2 serving as both the first and second overlay layers, encapsulating a transparent core layer 1. The figure displays two distinct regions: one where an insert 3 is included within a pre-fabricated window 6, and another where the window 6 lacks an insert, highlighting the role of inserts in maintaining window integrity during lamination. This side-by-side comparison within the same figure underscores the effectiveness of inserts 3 in preventing distortion of the windows 6, a critical aspect in preserving the aesthetic and functional qualities of the multi-layered inlay.

The integration of inserts 3, as depicted in the upper section of the figure, is aligned with the multilayered inlay 50 claims, where inserts are arranged within the pre-fabricated windows 6 of both the first and second overlay layers 2, 10 to enhance security features, visual effects, and electronic functionality. These inserts 3, possibly comprising Optical Variable Materials (OVM), are essential in ensuring that each layer, especially the transparent core layer 1, adheres to its intended design purpose without succumbing to distortions that could impair the visibility and effectiveness of embedded security elements such as antenna traces or electronic wires.

Moreover, this detailed arrangement supports the multilayered inlay 60's requirements for the visibility of internal components such as antennas 5 or chip modules 4 through the windows 6. This visibility is not only crucial for verifying the presence and integrity of electronic modules but also for enhancing the security and aesthetic appeal of the inlay, leveraging specific visible patterns that are difficult to replicate. The comparison shown in FIG. 4 vividly illustrates how the presence or absence of inserts 3 can affect these crucial aspects, validating the design considerations highlighted in the method 100 for assembling an inlay 7, 60. This method includes detailed steps for arranging these inserts 3 to prevent window 6 distortion during the lamination process, ensuring the proper placement of each layer, and maintaining the alignment and integrity of the materials despite their differing properties.

In essence, FIG. 4 serves as a comprehensive showcase of the lamination techniques and material arrangements that are critical in achieving the high standards required for functional, secure, and visually appealing multi-layered inlays. It provides a clear demonstration of the technological foresight involved in designing and implementing structures that meet stringent security and functional specifications. This figure thus encapsulates the complex interplay between material properties, design precision, and functional requirements in the manufacturing of advanced security inlays.

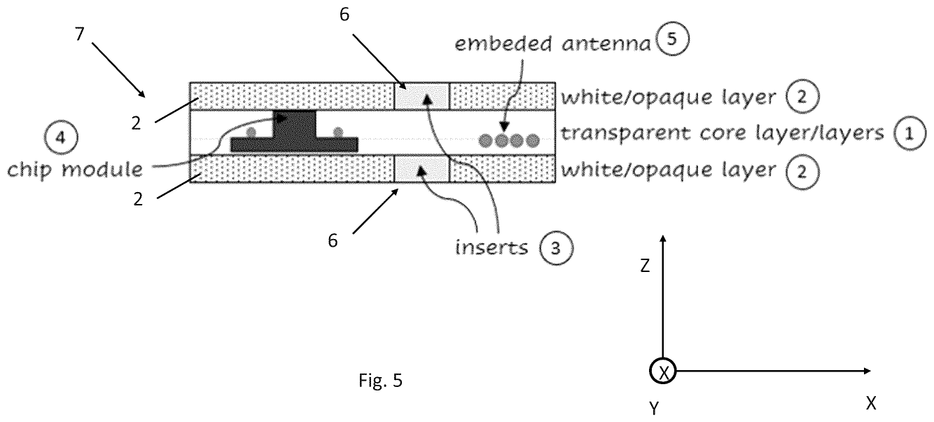

FIG. 5 displays a multi-layered inlay 7, where advanced lamination techniques and material integration are used to construct a secure and operational structure. This figure reveals how the inlay incorporates several key elements from the claims to form a durable and secure product. The inlay 7 comprises a core layer 1 positioned between two white/opaque layers 2, each containing pre-fabricated windows 6 designed to accommodate inserts 3.

The assembly begins by providing the first overlay layer 2 with pre-fabricated windows 6, as stipulated in the claims. These windows are carefully crafted to precise dimensions to ensure they can house inserts 3 that prevent any distortion during lamination. The core layer 1 is then placed on this first overlay layer, with the core designed to integrate a chip module 4 and an embedded antenna 5, enhancing the inlay's functionality.

As per the claims, inserts 3 are placed within the windows 6 of both the first and second overlay layers 2, 10, employing techniques such as ultrasonic welding to achieve a secure bond without misalignment. This step ensures the inserts maintain their position and structural integrity throughout the lamination process. The second overlay layer 2 is similarly provided and arranged atop the core layer 1, incorporating additional inserts 3 in its windows 6. These layers and inserts 3 are then subjected to a lamination process under specific heat and pressure conditions, ensuring thermal bonding between the layers without compromising material integrity.

This lamination involves both the application of heat to meld the materials and subsequent active cooling under pressure as specified in the claims. This cooling stabilizes the bonded structure, solidifying the melded components into a single, integrated inlay. The claims further describe a transitional region between the inserts and overlay layers where the materials interlace during the heating process, allowing molten materials from both the insert and overlay to penetrate each other and lock mechanically after hardening, achieving a bond without additional adhesives.

The entire process is designed to adhere to rigorous standards, ensuring each pre-fabricated window in the overlay layers meets specific size requirements with a tolerance for precise security feature dimensions. The design also accounts for the reduction of stress concentrations by implementing windows with rounded corners, enhancing the inlay's structural integrity.

Moreover, the inlay's configuration is tailored to include optical variable materials within the inserts 3 and possibly the core layer 1, providing distinct security features that are visually striking and difficult to replicate. These features, along with the embedded electronic components such as the chip module 4 and antenna 5, are strategically integrated to offer both enhanced security and functionality, ensuring the inlay 7 meets the specified demands for high-security applications in cards and documents.

FIG. 5 exemplifies a meticulous approach to designing a multi-layered inlay 7 that fully utilizes advanced materials and manufacturing techniques to meet detailed security and operational specifications set forth in the patent claims.

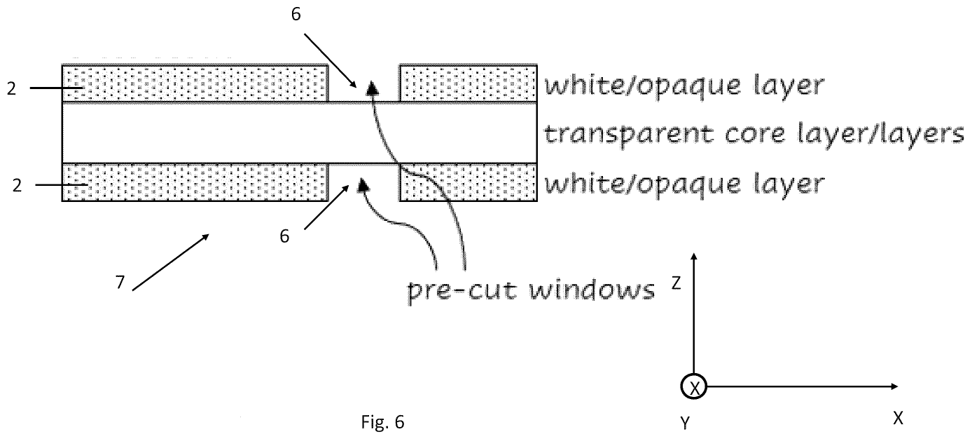

FIG. 6 provides a depiction of an inlay structure 7 that is designed for high security and functionality within a card or document, utilizing a layered composition that includes advanced electronic components. This inlay 7 comprises multiple layers, each playing a critical role in the protection and operational integrity of the embedded electronics.

The core of this inlay features a transparent core layer 1, placed centrally between two white/opaque layers 2. These layers are essential for providing structural support and concealing the internal components from unauthorized observation, thus enhancing security. The transparent nature of the core layer 1 is crucial as it accommodates sophisticated electronic components, including a chip module 4 and possibly an antenna 5, enabling visibility and verification of these components through pre-fabricated windows 6 cut into the overlay layers.

These windows 6 are a focal point of the design, strategically placed to align with the underlying electronic components. They allow not only for the visual verification of the components' presence and integrity but also serve as aesthetic enhancements to the card's design. By allowing certain parts of the antenna 5 or chip module 4 to be visible, these windows can incorporate specific visible patterns or configurations, making the design difficult to replicate without appropriate manufacturing capabilities.

The placement of inserts 3 within these windows 6 further stabilizes the structure. These inserts 3 are designed to prevent the distortion of the windows during lamination, ensuring that the visibility and aesthetic appeal are maintained even under physical stress. The use of materials such as polycarbonate (PC), polyvinyl chloride (PVC), or polyethylene terephthalate glycol-modified (PETG) in the core 1 and overlay layers 2, 10 provides a robust structure that is both durable and capable of supporting high-quality security features.

The lamination process itself is finely tuned, involving precise heat and pressure application to bond the layers seamlessly without additional adhesives. This method not only secures the internal components but also activates the optical variable materials within the inserts, enhancing the inlay's security features with characteristics like color shifts or holographic patterns.

Moreover, the construction of this inlay follows stringent specifications to ensure that every component aligns perfectly. The pre-fabricated windows have minimum size requirements and specifically designed corner radii to reduce stress concentrations, which helps in maintaining the structural integrity of the inlay under duress. The dimensions and shapes of these windows are crafted to meet security standards while also allowing for the durability and visibility of the embedded features.

FIG. 6 shows a high-security multilayered inlay 7 that is not only functional and robust but also aesthetically pleasing and difficult to counterfeit. This design represents an advanced approach to modern security needs, blending technology and materials science to protect and verify sensitive electronic components in a secure and visually verifiable manner.

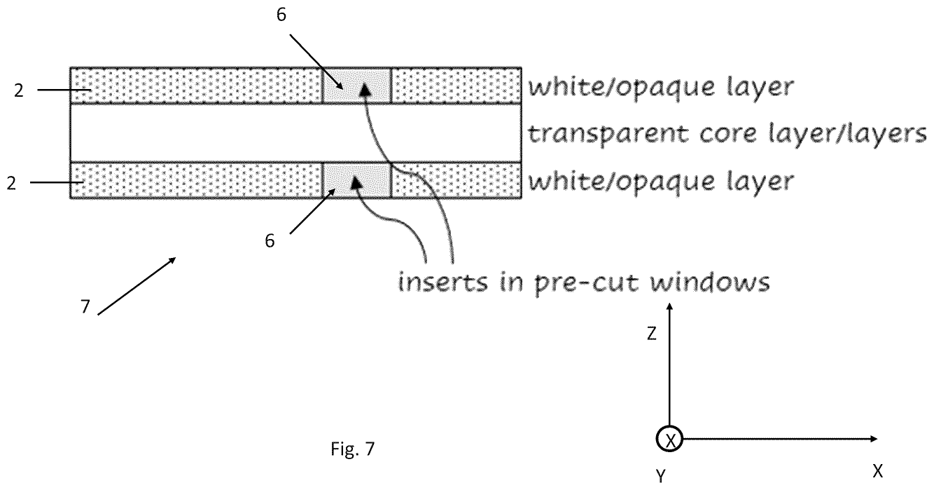

FIG. 7 illustrates a stage in the assembly of a multi-layered inlay 7, demonstrating the integration of technology and material science to enhance the security and functionality of laminated devices. This figure showcases the inlay 7 just before the final lamination process where inserts 3 are strategically positioned within pre-fabricated windows 6 on both the first and second white/opaque overlay layers 2.

Starting with the provision of the first and second overlay layers 2, each equipped with precisely sized pre-fabricated windows 6, the method involves the precise placement of inserts 3. These inserts 3 are made from optical variable materials and are designed to fit snugly within these windows 6, helping to maintain the intended visual and security characteristics of the inlay 7. The core layer 1, sandwiched between these overlay layers, is designed to be transparent, contributing to the aesthetic and functional aspects of the inlay by allowing for the visibility of embedded security features while also providing a substrate for additional components.

The placement of inserts 3 involves a series of detailed techniques to ensure their proper alignment and bonding without the use of additional adhesives. Ultrasonic welding is employed to bond the inserts securely to the overlay layers, a method that aligns with the claims of enhancing the structural integrity and alignment of the inlay's components. This process not only ensures the mechanical lock but also involves a hot joining technique where the materials of the inserts and the overlay layers interlace when subjected to heat. This interaction results in molten materials from both components penetrating each other, subsequently hardening to form a secure mechanical bond.

The pre-fabricated windows 6 in the overlay layers 2 are meticulously designed with corners having a minimum radius greater than 0.2 mm to reduce stress concentrations, and each window is ensured to meet specified dimensions of at least 5.0×5.0 mm with a 10% tolerance. These specifications are crucial for maintaining the integrity and security standards of the inlay. Moreover, the design of any lines or poles in the window is tailored to be wider than 2.0 mm to ensure durability and clear visibility of embedded features.

Following the alignment and placement of inserts, the inlay undergoes a critical lamination process. This process is performed under controlled heat conditions, approximately 175 °C, for a specified duration to achieve optimal adhesion while preserving the material properties of the layers involved. Active cooling under pressure immediately follows the heating phase to stabilize the newly formed bonds and ensure the inlay's robustness and readiness for subsequent integration into higher assembly processes, such as embedding in card or document formats.

Each layer and insert 3 within FIG. 7 are chosen not only for their functional contributions but also for their compatibility and performance under the conditions described, ensuring that the final product not only meets but exceeds the stringent requirements set forth in the associated claims. The combination of high-opacity materials, optical variable materials, and precise fabrication and bonding techniques exemplifies a sophisticated approach to creating secure, durable, and functional inlays suitable for a variety of high-security applications.

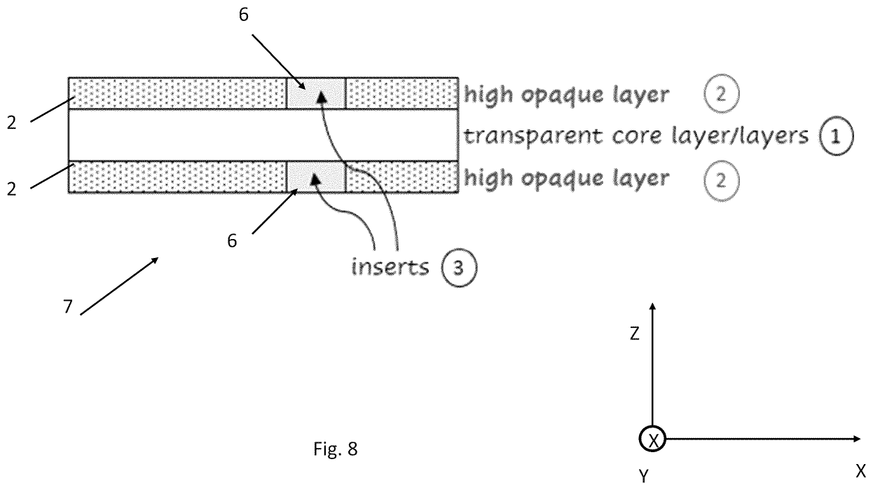

FIG. 8 illustrates an intermediate stage of assembling a high-security multilayered inlay 7, where strategic material and process choices ensure both functionality and security. This figure specifically shows the assembly of first and second high-opaque overlay layers 2 with embedded transparent core layer 1, sandwiching inserts 3 within pre-fabricated windows 6. The depiction highlights a meticulous approach to enhancing security features while maintaining the structural integrity required for high-performance applications.

The assembly begins with providing two high-opaque overlay layers 2 that have pre-fabricated windows 6 designed to meet specific size and tolerance requirements. These windows are crafted to have a minimum size of 5.0×5.0 mm with a tolerance of 10%, ensuring they can accommodate the designed inserts 3 without compromising the overlay structure. The corners of these windows are engineered with a minimum radius greater than 0.2 mm to diminish stress concentrations, enhancing the durability and longevity of the inlay.

Inserts 3, composed of an optical variable material (OVM), are meticulously positioned within these windows. The OVM is selected not only for its security features, providing color shift or UV fluorescence, but also for its compatibility with the lamination process. These materials are capable of undergoing a hot joining process, where they are bonded to the overlay layers 2 without the need for additional adhesives. This is achieved through a controlled heating process where both the inserts and the overlay material interlace at a molecular level, creating a mechanical lock as they cool and solidify, ensuring a secure and permanent bond.

The core layer 1 sandwiched between the overlay layers 2 is transparent, enhancing the visibility of the inlay's internal components, including any embedded electronic modules such as a chip module 4 or an antenna 5. This transparency is crucial not only for aesthetic reasons but also for functional inspections and security verifications.

The lamination process itself is carefully controlled, involving the application of heat around 175 °C for a precise duration to achieve optimal adhesion without degrading the materials. Following the heat application, an active cooling process is initiated under pressure to stabilize the assembled structure quickly. This rapid cooling helps to lock the configuration in place and prevents any warping or misalignment that could compromise the inlay's functionality.

Additionally, the ultrasonic welding technique is employed to ensure that the inserts 3 remain perfectly aligned within their designated windows 6 during the lamination process. This method helps maintain the precise positioning of the inserts, critical for the inlay's performance and durability.

This multilayered inlay 7 is then prepared for further integration into security documents or chip cards, leveraging its enhanced structural integrity, security features, and electronic compatibility. The entire assembly process underscores the integration of advanced materials and sophisticated manufacturing techniques to produce a security-enhanced, functional, and reliable product suitable for a variety of demanding applications.

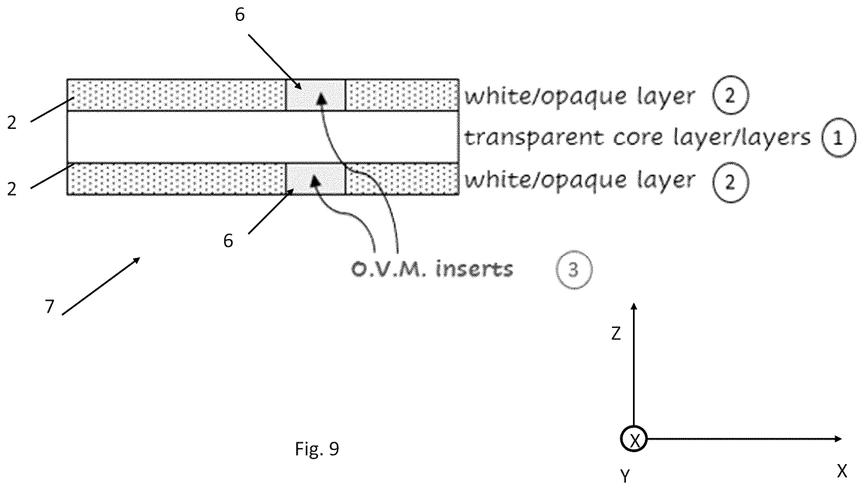

FIG. 9 presents a detailed view of a multilayered inlay 7, showing an advanced assembly designed for security and functionality. This illustration features a transparent core layer 1 flanked by two high-opaque overlay layers 2, with optical variable material (O.V.M.) inserts 3 embedded within pre-fabricated windows 6. The construction is tailored for optimal integration of electronic components while ensuring high security standards through material choice and assembly techniques.

The assembly process of the inlay 7 begins by providing first and second high-opaque overlay layers 2, each prepared with precisely sized pre-fabricated windows 6. These windows 6, designed to comply with strict dimensional tolerances, measure at least 5.0×5.0 mm with a 10% tolerance, incorporating corners rounded to more than 0.2 mm to mitigate stress concentrations. The strategic design of these windows plays a crucial role in maintaining the structural integrity of the inlay while facilitating the incorporation of security-enhancing features.

Within these windows 6, inserts 3 made of an optical variable material are precisely positioned. This material is chosen for its unique properties, such as color shift or UV fluorescence, which are critical for security applications. The inserts 3 also contribute to the overall durability and visual consistency of the inlay 7 by having a minimum thickness of 30 μm, preferably 50 μm, aligning with the opacity requirements of the overlay layers 2, 10.

The core layer 1, sandwiched between the overlay layers 2, 10, is transparent, allowing for visual inspection and the functionality of embedded electronic components, such as a contactless chip module 4 or an embedded antenna 5. The transparency is essential not only for aesthetic purposes but also for functional checks and security verifications.

The integration of these layers involves a sophisticated lamination process where heat is applied—typically around 175 °C for about 15 minutes—to fuse the layers effectively without compromising their individual and collective integrity. This thermal bonding is enhanced by a controlled cooling process under pressure, ensuring the assembled structure is stabilized quickly to prevent any misalignment or warping.

Moreover, the assembly technique includes the innovative use of ultrasonic welding to secure the inserts 3 within their designated windows 6. This method ensures that the inserts remain perfectly aligned and bonded to the overlay layers, thereby maintaining the precision and alignment crucial for the inlay's performance and security features.

In transitions between the inserts 3 and the overlay layers 2, 10, a hot joining technique is employed where the materials of the inserts 3 and the overlay layers interlace at a molecular level. This method eliminates the need for additional adhesives by allowing the materials themselves to melt, merge, and then mechanically lock as they solidify, forming a durable and secure bond that enhances the inlay's integrity.

This detailed view of FIG. 9 encapsulates a methodical approach to constructing a multilayered inlay that balances functionality, security, and structural integrity. It demonstrates the application of advanced materials and techniques in creating a product that meets stringent security standards while accommodating sophisticated electronic components within a robust and reliable structure.

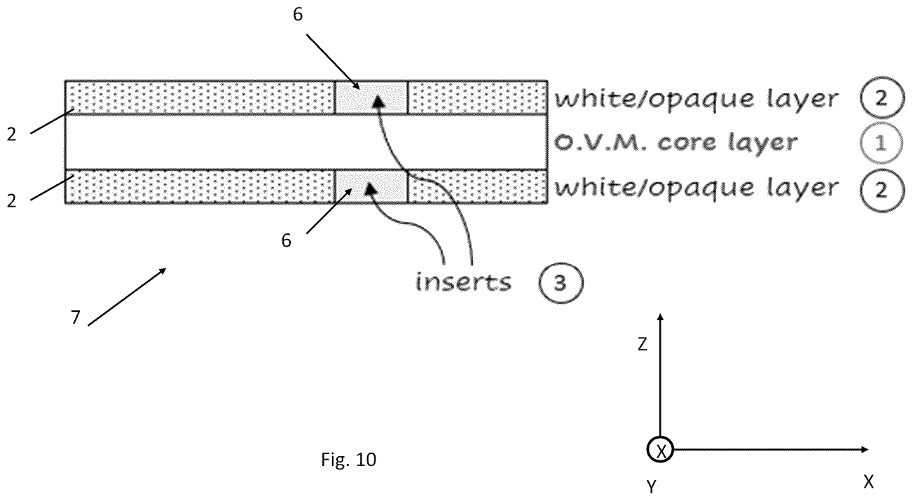

FIG. 10 depicts an advanced multilayered inlay 7, highlighting the strategic integration of security features through the use of optical variable material (O.V.M.) layers and precision-engineered components. This embodiment incorporates a central O.V.M. core layer 1 situated between two high-opaque layers 2, with specifically designed inserts 3 positioned within pre-fabricated windows 6.

The construction process begins with the provision of first and second high-opaque overlay layers 2. These layers are critical for ensuring the concealment of underlying security components while also providing structural support. Each layer 2, 10 includes pre-fabricated windows 6, engineered to precise dimensions to facilitate the integration of inserts 3 without distorting their shape during the lamination process. The windows 6 adhere to stringent specifications, having a minimum size of 5.0×5.0 mm with a tolerance of 10%, and corners designed with a radius greater than 0.2 mm to reduce stress concentrations and enhance durability.

The core layer 1, made from an optical variable material, lies inside of the inlay 7. This material is selected for its dynamic visual effects, including color shifts and UV fluorescence, which significantly enhance the security and aesthetic appeal of the inlay 7. The layer's transparency not only contributes to the visual effect but also plays a functional role by allowing visual verification of the integrated security features.

Inserts 3 are positioned within the windows 6 using a precise alignment technique, possibly employing ultrasonic welding to secure them in place. This ensures the inserts 3 are perfectly aligned within the high-opaque overlay layers 2, maintaining the inlay's integrity and alignment. The use of optical variable material in the inserts adds another layer of security, providing unique visual identifiers that are difficult to replicate.

A critical aspect of the assembly is the hot joining technique applied in transitional areas between the inserts 3 and the overlay layers 2. This process involves melting the contact points between the inserts and the layers, allowing the materials to interlace and lock mechanically as they solidify. This method ensures a strong, adhesive-free bond that enhances the structural integrity of the inlay.

The entire assembly undergoes a controlled lamination process, where heat and pressure are meticulously applied to bond the layers effectively. The process is fine-tuned to achieve optimal adhesion at about 175 °C for 15 minutes, ensuring that the bonding enhances the inlay's durability without compromising the materials' quality. Following lamination, an active cooling process is initiated, rapidly stabilizing the newly formed structure and preventing any thermal distortion that could impact the inlay's functionality.

This description of FIG. 10 reflects an intricate synthesis of materials and techniques designed to create a high-security inlay that is robust, visually distinctive, and capable of integrating advanced electronic components such as chip modules and antennas. The multilayered structure not only meets high security and functional standards but also aligns with stringent manufacturing specifications to ensure consistency and quality in mass production.

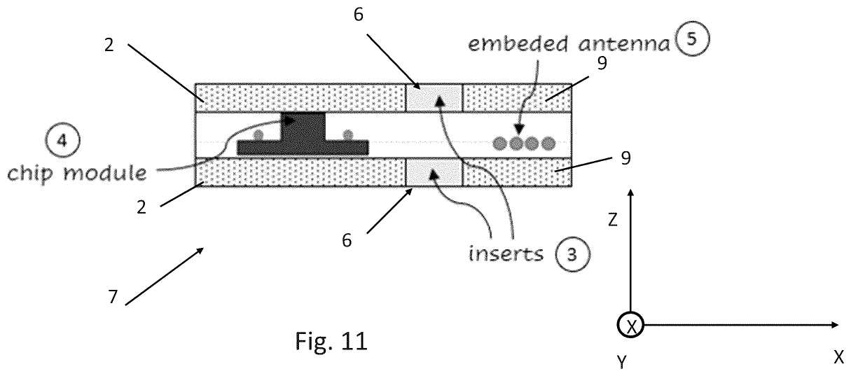

FIG. 11 illustrates a sophisticated inlay 7 designed to incorporate advanced security features through strategic material choices and integration techniques. This embodiment showcases a multilayered structure, including top and bottom high-opaque layers 2 that enclose a chip module 4 and an embedded antenna 5 within a core layer, detailed by the presence of optical variable materials (O.V.M.) enhancing security attributes.

In this detailed depiction, the process begins with the provision of two high-opaque layers 2, each integrated with pre-fabricated windows 6. These windows are crafted to precise specifications, each ensuring a minimum size of 5.0×5.0 mm with a 10% tolerance and designed with softened corners to enhance structural integrity and reduce stress concentrations. The windows accommodate inserts 3, which are configured to remain distortion-free during lamination, thus maintaining their precise alignment and functionality.

Central to the inlay's functionality is the core layer 1 that hosts the chip module 4 and an embedded antenna 5, demonstrating an advanced integration of electronic components within the security framework. The positioning of the chip module 4 and antenna 5 is critical, not only for the operational efficacy of the inlay but also for maintaining its security integrity. The antenna 5 is intricately embedded, possibly using techniques such as wire embedding, to ensure seamless connectivity and performance.

The inserts 3 incorporated into this setup are not just filler materials but are composed of optical variable materials. These materials are chosen for their ability to display unique visual effects, such as color shifts and UV fluorescence, enhancing the security level of the inlay. The integration of such materials requires precise temperature and pressure conditions during lamination to prevent degradation of the optical properties and to ensure perfect adhesion without the use of additional adhesive materials.

The lamination process itself is carefully controlled, applying heat around 175 °C for approximately 15 minutes. This ensures optimal adhesion of the layers while preserving the integrity and functionality of the embedded and surrounding materials. Following the heat application, an active cooling process under pressure is implemented to stabilize the bonded structure rapidly, ensuring that the layers solidify into a cohesive unit without any thermal distortion.

Moreover, the assembly process may involve techniques such as ultrasonic welding to bond the inserts 3 within the pre-fabricated windows 6 firmly. This method is particularly beneficial for maintaining the alignment and positioning of the inserts, crucial for the inlay's performance and durability. Additionally, the transitional regions between the inserts and the overlay layers may undergo a process of interlacing at the molecular level, where the materials are heated and allowed to intermingle and lock mechanically, creating a robust bond without external adhesives.

This detailed construction of the inlay 7 not only meets high security and functional standards but also aligns with stringent manufacturing specifications to ensure consistency and quality in mass production. The comprehensive integration of advanced materials and sophisticated assembly techniques highlights the inlay's capability to serve high-security applications effectively, providing a reliable and tamper-resistant solution in the form of an advanced multilayered inlay system.

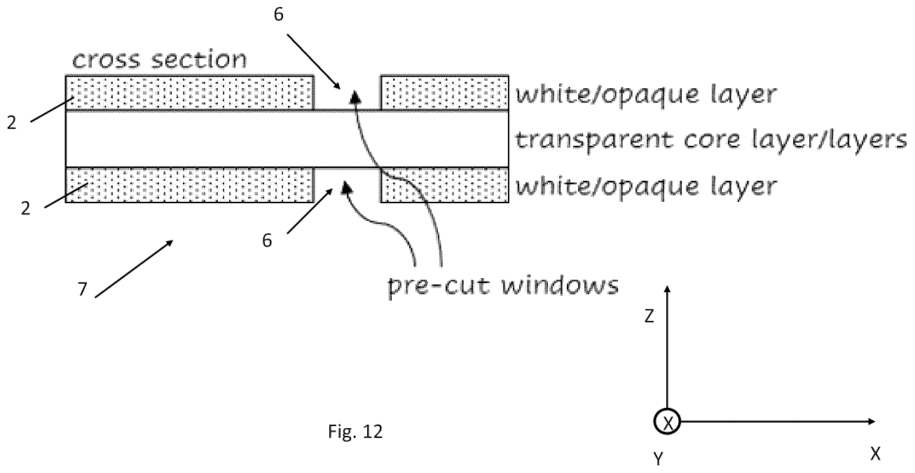

FIG. 12 shows an inlay structure 7 that is meticulously designed to combine functionality with high security, employing a layered composition optimized for embedding electronic components within a secure environment. The depiction focuses on a multilayered configuration that is fundamental in ensuring both the physical integrity and the operational efficiency of the embedded systems.

At the core of the inlay lies the transparent core layer 1, sandwiched between two white/opaque layers 2. This central transparent layer is crucial as it hosts the embedded electronic components and allows for selective visibility of these components through strategically placed pre-cut windows 6. These windows 6 are not merely functional but are crafted to enhance the aesthetic value of the card or document while providing a visual check of the integrity and presence of the electronic components housed within.

The white/opaque layers 2 that flank the transparent core 1 serve multiple purposes. Primarily, they act as protective barriers shielding the electronic components from external environmental factors and unauthorized scanning attempts, thereby enhancing the security level of the card. Additionally, these layers contribute to the overall aesthetic by providing a clean and uniform background that can be customized with print or design as needed.

The pre-cut windows 6 in these overlay layers 2, 10 are precisely engineered to align perfectly with the components beneath them, such as antenna traces or chip modules. This alignment is not only crucial for functional visibility but also plays a significant role in security. By allowing certain elements of the electronic components to be visible, the windows serve as a security feature, presenting unique patterns that are challenging to replicate without the specific manufacturing capabilities. This method of visibility can also be used to verify the authenticity of the card directly.

The design and assembly of this inlay 7 follow stringent specifications to ensure durability and compliance with security standards. The windows 6 are designed with specific minimum sizes and corner radii to reduce potential stress points that could lead to structural weaknesses. Moreover, the widths of the lines or poles in the window design are carefully considered to balance visibility with durability, ensuring that the embedded features are sufficiently robust to withstand regular use without degradation.

FIG. 12 illustrates a sophisticated approach to designing secure inlays for modern cards and documents, integrating advanced material technology and precise engineering to create a product that is both secure and visually appealing. This inlay structure leverages the strength and transparency of its materials to protect and display critical electronic components effectively, making it an ideal choice for high-security applications.

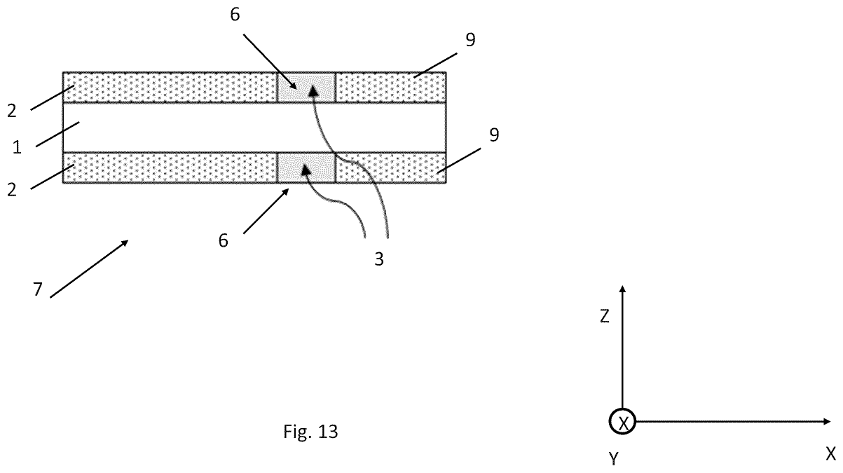

FIG. 13 depicts an advanced multilayered inlay 7, which is designed to offer a robust and secure structure for high-security applications such as identity documents and smart cards. This embodiment is centered on a core layer 1 sandwiched between two high-opaque layers 2, 10, which are crucial for maintaining the confidentiality of the internal components. The core layer 1, potentially composed of materials like polycarbonate (PC), polyvinyl chloride (PVC), or polyethylene terephthalate glycol-modified (PETG), also features transparent windows 6 that house inserts 3 made from optical variable materials, thus providing additional security features through visual effects like color shifts or UV fluorescence.

The construction of this inlay 7 starts with the provision of the first high-opaque overlay layer 2, equipped with pre-fabricated windows 6. These windows are meticulously designed to precise dimensions (5.0×5.0 mm with a tolerance of ±10%), featuring corners with a minimum radius greater than 0.2 mm to reduce stress concentrations and enhance durability. The first insert 3 is then precisely positioned within these windows 6 using advanced techniques such as pick-and-place followed by microbonding, ensuring that each insert is securely bonded without damage to the surrounding materials.

Following the placement of the first overlay 2, 10, the core layer 1 is carefully aligned on top of it. This layer not only provides structural integrity but also hosts various security elements, including possibly a chip module or an embedded antenna, which are integrated using sophisticated techniques like wire embedding, printing, or etching to ensure seamless functionality.

A second high-opaque overlay layer 2, 10, identical to the first and also featuring pre-fabricated windows 6, is then positioned over the core layer 1. A second set of inserts 3, identical to the first and made from the same optical variable material, is aligned and secured within these windows. This mirroring arrangement enhances the inlay's integrity and security features.

The entire assembly is subjected to a controlled lamination process, where heat (approximately 175 °C for 15 minutes) and pressure are applied. This process not only ensures that all layers bond together into a single cohesive unit but also activates the properties of the optical variable materials without compromising their integrity. After lamination, an active cooling process under pressure is employed to stabilize the bonded structure, ensuring that the layers solidify without any thermal distortion.

During the lamination process, special attention is given to the transitional regions between the inserts 3 and the overlay layers 2. Here, a hot joining technique is applied where the materials of the inserts and the overlays interlace at the molecular level. This is achieved by heating both components until they melt slightly, allowing their molten materials to intermingle and then mechanically lock together as they cool, forming a strong, adhesive-free bond.

Finally, the entire inlay assembly is manufactured in a larger inlay sheet 16, from which individual inlays 7 can be extracted using precision cutting techniques. This allows for the mass production of secure inlays 7, each maintaining high quality and uniformity.

This detailed description of FIG. 13 not only illustrates the technical aspects of assembling a secure inlay but also emphasizes the integration of multiple security layers and advanced materials, all aimed at enhancing the functionality and security of the final product.

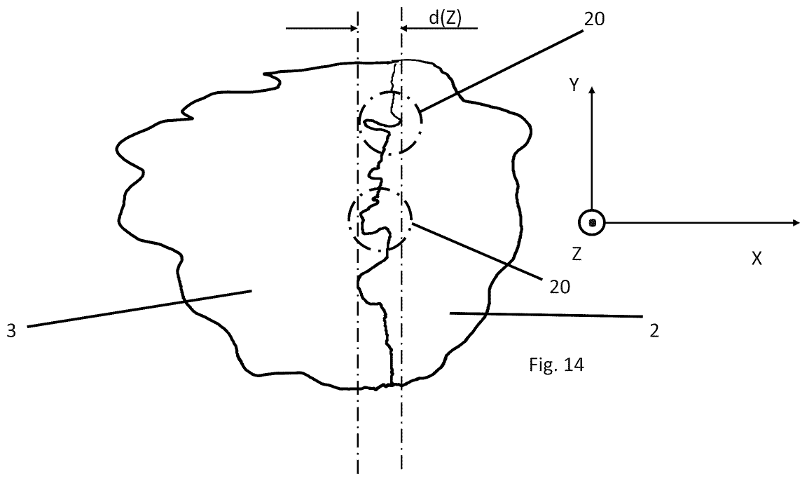

FIG. 14 presents an intricate view of a transitional region 20 in an inlay 7 that demonstrates a high level of technical innovation in materials integration and bonding methods. This figure focuses on a highly specialized aspect of inlay construction where materials undergo fusion without the use of adhesives, relying instead on their intrinsic properties to form a robust, integrated structure.

In this detailed illustration, the transitional region 20 is shown as the area where the material of an insert 3 intersects with the material of the overlay layers 2. Both the insert 3 and the overlay layers 2 include advanced optical variable materials, which provide security features through unique visual effects such as color shifts or patterns that are only visible under specific lighting conditions. These materials not only enhance security but also contribute to the mechanical and visual integrity of the final product.

The construction process begins with the alignment of the insert 3 within a pre-fabricated window 6 located in the first overlay layer 2. This is a critical step as it ensures that the insert 3 is precisely positioned to maintain the designed aesthetic and functional aspects of the inlay 7. Following this, a core layer 1, potentially comprising materials such as PC, PVC, or PETG, is placed to span across the first and second overlay layers 2, enveloping the insert 3. The second overlay layer 2 is then aligned over the core layer 1, creating a sandwich structure that encases the insert 3.

A notable feature in this structure is the employment of ultrasonic welding, a technique chosen to bond the inserts 3 securely within the windows 6 of both the first and second overlay layers 2. This method is particularly advantageous as it provides a strong bond that maintains the alignment and positioning of the inserts 3 without additional adhesives, thus preserving the clarity and functionality of the optical variable materials within the inserts.

The entire assembly undergoes a lamination process where heat is applied (approximately 175 °C for 15 minutes). This heat is sufficient not only to bond the layers together but also to activate the properties of the optical variable materials within the inserts 3, ensuring they fuse seamlessly with the overlay layers 2. The lamination is closely followed by an active cooling process under pressure, which is critical to stabilizing the bonded structure, ensuring that it solidifies without warping or thermal distortion.

This figure also underscores the importance of precise material engineering, especially in the way the transition regions 20 are designed. Here, the materials of the insert 3 and the overlay layers 2 interlace at a molecular level when heated, allowing them to melt slightly and mix before locking mechanically as they cool. This interlacing is critical as it forms a mechanical bond that significantly enhances the durability and security of the inlay without the need for external adhesives.

Moreover, the dimensions and shapes of the windows 6 are meticulously designed to ensure they comply with the security specifications, with each window having a minimum size and corner radii to reduce stress concentrations, thus enhancing the structural integrity of the inlay.

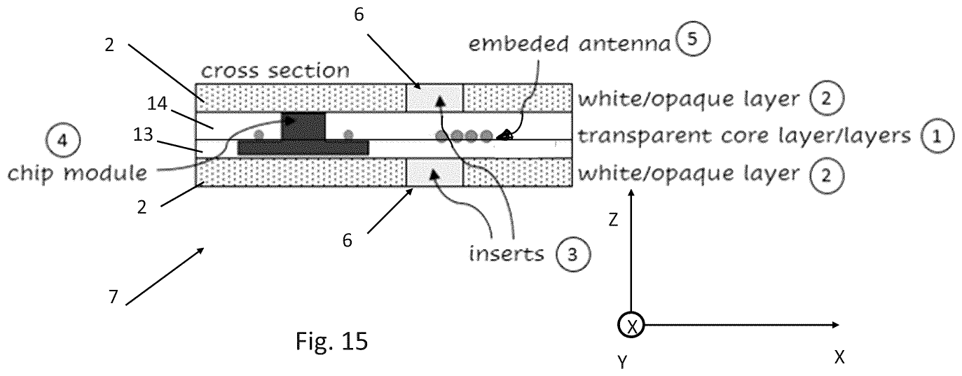

FIG. 15 illustrates a sophisticated cross-sectional view of an inlay 7, emphasizing the layering and integration of various components crucial for ensuring the functionality and security of the inlay 7. This figure highlights the advanced construction methodology applied in creating a multilayered inlay 7 that includes an embedded chip module 4 and antenna 5, strategically encased within several layers that provide both security and structural integrity.

The core of the inlay 7 comprises a transparent core layer 1, selected for its properties that can include materials such as polycarbonate (PC), polyvinyl chloride (PVC), or polyethylene terephthalate glycol-modified (PETG). This layer is crucial as it supports the electronic components—specifically, a contactless chip module 4 and an embedded antenna 5—that are integrated using techniques like wire embedding, printing, or etching, which are not visible in the figure but are implied by their functional necessity.

Including the core layer 1 are multiple white/opaque layers 2 that serve as the first and second overlay layers 2, 10. These layers are engineered to obscure the underlying components, enhancing the security of the chip 4 and antenna 5. The specified materials for these layers could also include PC, PVC, or PETG films, noted for their durability and effectiveness in protecting the electronics from environmental factors and unauthorized tampering.

Embedded within these layers are strategically placed inserts 3, depicted at the positions of the pre-fabricated windows 6. These inserts 3 are made from an optical variable material that not only strengthens the structure but also provides unique visual security features such as color shifts or holographic patterns, which increase the authentication capabilities of the inlay.

The assembly process begins with the placement of the first insert 3 within the window 6 of the first overlay layer 2, followed by the alignment of the core layer 1, which then receives the second insert 3 within the second overlay layer 2. The precise positioning of these inserts 3 is crucial for maintaining the overall alignment and integrity of the inlay structure. The design of the windows 6 includes specific dimensions and corner radii to minimize stress concentrations and enhance the durability of the inlay.

The entire structure is then subjected to a lamination process, where heat and pressure are applied to achieve a seamless bond between the layers without the use of additional adhesives. This process involves a detailed control of temperature—approximately 175 °C for 15 minutes—to ensure that the layers fuse properly and the optical variable materials are activated without degrading.

Following the lamination, an active cooling process under pressure is implemented to stabilize the bonded structure. This step is critical to ensure that the thermal bonding is solidified, maintaining the precise placement of each layer and insert, and preserving the functional and security features of the inlay.

Overall, FIG. 15 provides a detailed depiction of the construction of a high-security, multilayered inlay 7 that utilizes advanced materials and manufacturing techniques to create a product that is not only secure but also robust and reliable. The integration of electronic components within a protective and visually verifiable structure showcases the technological sophistication involved in modern security inlay design.

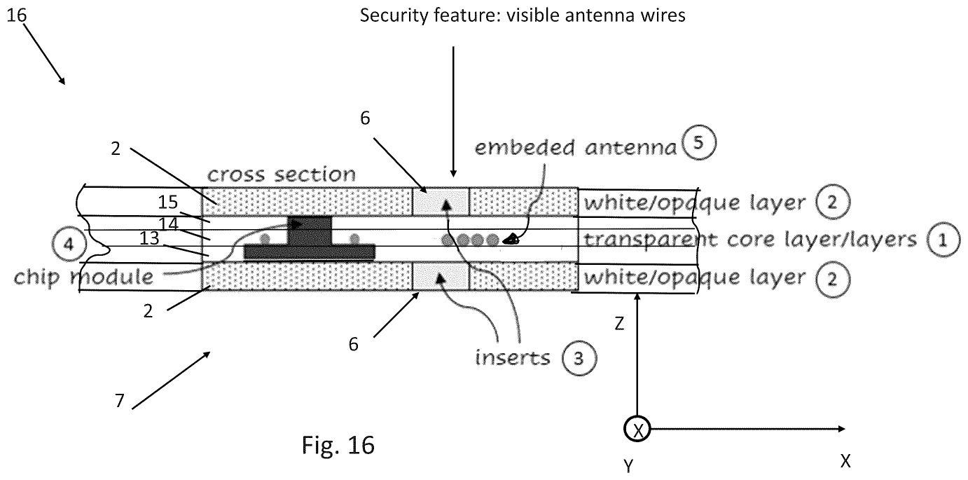

FIG. 16 illustrates a sophisticated multilayered inlay 7, designed with intricate layers and embedded electronic components, providing both advanced security features and functional benefits for smart cards or secure documents. This depiction demonstrates how various materials and configurations are employed to achieve both durability and security integrity.

At the core of this structure is the transparent core layer 1, which is essential for housing significant electronic components such as a chip module 4 and an embedded antenna 5. The transparency of this layer is pivotal for the visibility of embedded components, which is integral to the security and verification features of the inlay 7. It allows for the visual inspection of the antenna wires, ensuring their proper integration and function.

Surrounding the transparent core layer 1 are multiple white/opaque layers 2. These layers are situated both above and below the core layer, providing a protective barrier and enhancing the contrast, which aids in the visibility of the internal components through the pre-cut windows 6. These layers not only protect the delicate inner core but also contribute to the overall structural stability of the inlay.

In this configuration, additional specialized layers augment the inlay's functionality and integrity:

The lower transparent core layer 13 contacts directly with the underside of the first overlay layer 2, 10, providing a base for the core layer 1.

Above it, an upper transparent core layer 14 is placed, which may consist of one or more layers, adding to the thickness and visibility depth, aiding in the protection and display of the embedded antenna 5 and chip module 4.

A height adjustment transparent core layer 15 is added atop the upper transparent core layer 14, fine-tuning the spacing and alignment of the topmost elements to the rest of the assembly.

The inlay 7 includes pre-cut windows 6, placed in the first and second overlay layers 2, 10. These windows are critical as they are designed to align perfectly with the underlying embedded antenna 5, ensuring its visibility and enhancing the security feature by making the antenna wires noticeable. These windows not only serve a functional purpose but also contribute to the aesthetic and verification aspects by allowing visible access to the internal wiring, which can be designed in specific patterns that are difficult to replicate.

Inserts 3 are precisely positioned within these pre-cut windows 6 to prevent any distortion during the lamination process. These inserts could be made of optical variable materials that provide unique visual effects, thereby enhancing the security against replication attempts. They ensure the windows maintain their clarity and structural integrity, preventing any material flow that could obscure the view of the internal components.

The entire assembly is subjected to a carefully controlled lamination process. This process is essential for bonding the layers and inserts together without shifting, preserving the precise arrangement of each component. The lamination involves applying significant heat, approximately 175 °C, ensuring that each layer bonds thoroughly while maintaining the material properties and alignment.

FIG. 16 showcases a detailed and deliberate design aimed at enhancing security through visibility, structural integrity, and advanced material use, making this inlay ideal for high-security applications in smart cards and secure documents. Each element from the layers, inserts, windows, and electronic components plays a pivotal role in achieving the desired functional and security outcomes.

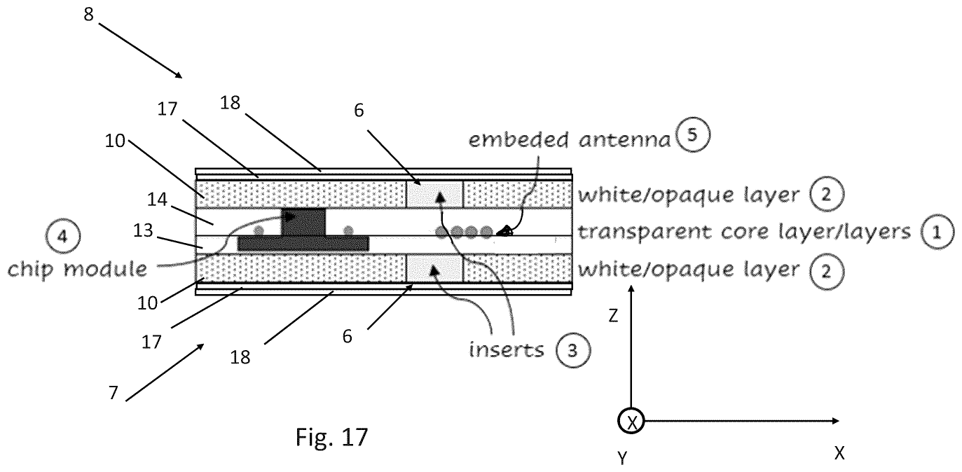

FIG. 17 shows an advanced multilayered inlay 7 that embodies a series of meticulously arranged layers and components, highlighting an integration of technology and security within a compact structure, typically employed in the fabrication of chip cards 8. This inlay is engineered to achieve high security and functional integration through its layered design and the strategic placement of electronic components.

At the foundation of this multilayered structure lies the transparent core layer 1, pivotal for its role in housing critical electronic components. This core layer allows for the integration of a chip module 4 and an embedded antenna 5, fundamental for the operational efficacy of the smart card. The transparency of this core layer 1 is crucial as it ensures the visibility of these components, which is essential not only for functionality but also for security verification purposes.

Surrounding the transparent core layer 1 are multiple white/opaque layers 2, which serve dual purposes. Primarily, these layers 2 act as protective barriers for the internal components. Secondarily, they enhance the visual contrast, making the internal components readily visible through strategic pre-fabricated windows 6. These windows 6 are essential for inspecting the integrity of the embedded components and serve as a security feature by making the antenna's wiring visible, thus providing a unique pattern that enhances the card's security against replication.

The design incorporates lower 13 and upper 14 transparent core layers that surround the main core layer, enhancing the structural integrity and visibility of the embedded components. A height adjustment transparent core layer 15 is also included, finely tuning the thickness and spacing within the inlay, ensuring that the overlay layers align precisely without disturbing the placement of the electronic components.

Inserts 3 are placed within the pre-fabricated windows 6 to maintain window clarity and to prevent the overlay layers 2 from distorting during the lamination process. These inserts potentially include optical variable materials that not only prevent visual distortion but also contribute to the security of the inlay by being difficult to replicate.

The overlay layers 10, shown as the first and second overlay layers, incorporate areas that remain clear of the opaque treatment to form windows 6. These windows 6 are aligned with the internal antenna 5, enabling the antenna's visibility which serves as both an aesthetic feature and a security element by confirming the presence and correct placement of the antenna and chip module.

Additionally, the design includes print layers 17 and transparent layers 18 which are added to the external surfaces of the first and second overlay layers 2, 10. These layers serve various functions including providing additional security features, improving the durability of the inlay, and allowing for further customization of the card's appearance.

The whole assembly is subjected to a lamination process where heat and pressure are meticulously applied to bond all layers and inserts securely. This process not only ensures the robustness and longevity of the inlay but also maintains the precise alignment of each component, critical for the functionality and security of the end product.

FIG. 17 exemplifies an inlay design that utilizes advanced materials and manufacturing techniques to create a secure, functional, and visually verifiable component for use in high-security applications such as smart cards and secure ID documents. This design effectively integrates transparency, reflectivity, and multiple layers to safeguard against unauthorized replication and ensure operational integrity.

It is further explained that the overlay and core layers 1 behavior when being melted and move during lamination, flowing into the gaps.

It is further illustrated how the transparent windows 6 mostly look like after lamination.

This application will intentionally focus on how to overcome a material shrinkage and distortion problem, the inserts 3 that are prepared in accordance with the size and shape of the pre-punched windows 6 of the opaque overlays 9 are used to fill in the gaps. And they would technically block or prevent the overlay and transparent core layers 1 from moving during lamination into the gaps, altering windows 6 shape and size.

The inserts 3 would prevent the material from moving freely into the gaps and help keep the transparent window 6 remain in the defined shape and size.

It is described that the different flowing behavior of the substrate when being melted during lamination, comparing between the product with and without the inserts 3.

It is also described an embodiment for a method for creating an inlay 7 for a card or document. The method involves providing a core layer 1 with two sides, designed to hold an electronic component. A first or upper overlay layer with a pre-fabricated window 6 is placed on one upper side of the core layer 1, while a second overlay layer with a pre-fabricated window 6 is placed on the other side. A first insert 3 is arranged within the window 6 of the first overlay layer to prevent distortion during lamination. An electronic component is integrated into the core layer 1. In a transitional region between the first insert 3 and the first overlay layer, the materials of the insert 3 and overlay layer interlace, creating a secure adhesive bond. This bond is achieved by applying heat, allowing the materials to melt, penetrate into each other, and mechanically lock together after hardening, forming a snug fit.

It is illustrated that an inlay 7 structure with transparent window 6 feature, consisting of 5 main components which are.

### Transparent Core Layer 1

can be any substrate such as PC film, a PVC film, or a PETG film.
single or multi layers.
transparent color, can be standard film, laserable and/or optical variable material.
thickness can vary, mainly depending on chip module 4 thickness.
the layer where antenna 12 and chip module 4 are embedded.

### White/Opaque Layer 2

can be any substrate such as PC film, a PVC film, or a PETG film.
single or multi layers.
“White/opaque” means that it can have white or opaque color.
thickness variable.
the layer where transparent windows 6 can be incorporated.

### Insert 3

can be any substrate such as PC film, a PVC film, or a PETG film.
transparent color, can be standard film, laserable and/or optical variable material.
chip module 4
contactless chip module 4.
can be memory and/or controller chip 11 where the data is stored.
communication with reader is done wireless through electromagnetic induction, using radio frequency, via embedded antenna 5 which is connected to the chip module 4.

### Embedded Antenna 5

copper based wire.
integrated into core layer 1 using wire embedding.
connected to chip module 4 using thermocompression.

The terms “chip module 4” and “copper wire”, and “embedded antenna 5” are used as a reference to electronic component parts in general, and the product design with the transparent window 6 feature can be applied using other chip 11 form factors and antenna 12 form factors, for instance bare die using flip chip 11 technology on a substrate where the antenna 12 is done by different technology and material such as printing or etching.

How the transparent windows 6 can be created and achieved. The opaque overlay layers 10 are to be prepared with pre-cut windows 6 in defined size and shape which are freely adaptable.

It is described that a second overlay layer with at least one pre-punched window 6 is placed on the second or lower side of the core layer 1. A second insert 3 is arranged within the lower window 6 of the second overlay layer to prevent distortion during lamination. In a transitional region between the second insert 3 and the second overlay layer, the materials interlace to create an adhesive bond, achieved by applying heat, allowing the materials to melt, penetrate into each other, and mechanically lock together after hardening.

Transparent core layer 1 which can be a single or multi layers and where the electronic components such as chip module 4 and antenna 12 are located, will be sandwiched by the opaque overlays 9 with pre-cut windows 6 on both sides. The opaque overlays 9 will create white plain inlay 7 surface, leaving the pre-cut areas seen through but key is to ensure that the pre-cuts are aligned on both sides during the layer collation process, (see also FIG. 5).

Technically the inlays 7 which are produced could already create transparent windows 6 but due to the fact that the inlays 7 in general are hot-laminated in high temperature and pressure under a certain period, Using the subject matter of the application, the material is prevented from getting melted and shrunk, specifically in the pre-cut areas, and from flowing freely and uncontrollably into the gaps. As the consequence, the shape and size of the windows 6 will not alter and stay in accordance with the defined dimensions.

It is described how the inserts 3 are used. As technically described shrinkage behavior of the material when being melted, the inserts 3 relevant to this application.

The inserts 3 can be standard transparent film, laserable and/or optical variable material. Their shape and size are freely adaptable which is in accordance with the pre-cuts of the opaque overlays 9.

The inserts 3 are not meant to change the shrinkage behavior of the material during hot lamination as it cannot be but in fact it will be specifically used to fill in to the pre-cuts, eliminating the gaps and preventing the overlay and core layers 1 from being melted into.

Therefore, the combination of using opaque overlays 9 with pre-cuts together with the inserts 3 filling techniques, it will not only be able to incorporate the transparent windows 6 into inlays 7 but also to offer an enhanced method to limit uncontrolled shrinkage and flowing behavior which cause a distortion to the windows 6 shape and size.

### Step 6—Optional Features

### Optional Feature: High Opaque Overlay

To be more specific on the material to be used as overlay, the idea behind is not to just use standard white/opaque color but to use high opaque. The advantage of high opaque material is that it will create solid white plain on the inlay 7 surface which covers visibility of chip module 4 and copper wire antenna 12. This will accommodate the customer to comfortably select transparent layers to be added during cards 8 production.

### Optional Feature: Optical Variable Material Inserts 3

The inserts 3 in general are standard transparent film but we can optionally replace it with optical variable material (see FIG. 8). The optical variable material is a colored transparent film which has characteristics such as color shift, UV strong fluorescence and etc. With the optical variable material as the inserts 3, it would introduce a more secured product.

With optical variable material, the color of the clear window 6 can switch between two colors depending on a bright or dark background. Integrated in transparent PC films used for clear window 6 applications, it is compatible with existing production processes. The optical variable material enables clear windows 6 in identification documents with a visual effect in security. A typical thickness of the optical variable material is about 100 μm. Under the flashlight of a smartphone or other conventional white light source, the insert 3 can turn into a second colour such as green, while it is in a shadow it remains in a first colour such as pink. The optical variable material can be provided according to the instructions given in the document WO2011064162.

### Optional Feature: Optical Variable Material Core Layer 1

Core layer 1 where the chip module 4 and antenna 12 are located, it is basically a standard transparent film but we can optionally replace it with optical variable material, (see FIG. 9). This will provide a more secured product and its unique characteristics of the optical variable material such as secondary color and strong fluorescence can be entirely seen on the edges.

### Step 7—Final Product

It is illustrated an inlay 7 structure with a transparent window 6 feature, consisting of 5 main components which are (except of the layer 13, 14, 17, 18).

### Transparent Core Layer 1

can be any substrate such as PC film, a PVC film, or a PETG film.
single or multi layers.
transparent color, can be standard film, laserable and/or optical variable material.
thickness can vary, mainly depending on chip module 4 thickness.
the layer where antenna 12 and chip module 4 are embedded.

### White/Opaque Layer 2

can be any substrate such as PC film, a PVC film, or a PETG film.
single or multi layers.
white/opaque color.
thickness variable.
the layer where transparent windows 6 can be incorporated.

### Inserts 3

can be any substrate such as PC film, a PVC film, or a PETG film.
transparent color, can be standard film, laserable and/or optical variable material.
chip module 4
contactless chip module 4.
can be memory and/or controller chip 11 where the data is stored.
communication with reader is done wireless through electromagnetic induction, using radio frequency, via embedded antenna 5 which is connected to the chip module 4.

### Embedded Antenna 5

copper based wire.
integrated into core layer 1 using wire embedding.
connected to chip module 4 using thermocompression.

The term “chip module 4” 4 and “copper wire embedded antenna 5” 5 are used as reference to electronic component parts in general, and the product design with the transparent window 6 feature can be applied using other chip 11 form factors and antenna 12 form factors, for instance bare die using flip chip 11 technology on a substrate where the antenna 12 is produced by different technology and material, such as printing or etching.

How the transparent windows 6 can be created and achieved: The opaque overlay layers 10 are to be prepared with pre-cut windows 6 in defined sizes and shapes which are freely adaptable.

Transparent core layer 1 which can be a single or multi layers and where the electronic components such as chip module 4 and antenna 12 are located, will be sandwiched by the opaque overlays 9 with pre-cut windows 6 on both sides. The opaque overlays 9 will create white plain inlay 7 surface, leaving the pre-cut areas seen through. In the next step, it is ensured that the pre-cuts are aligned on both sides during layers collation process, see FIG. 11.

Technically, the inlays 7 which are produced using the conceptual model in FIG. 5 can be seen as transparent windows 6 and because the inlays 7 in general are hot-laminated in high temperature and pressure during a certain period, the material gets melted and shrunk. Specifically in the pre-cut areas, creating gaps, the material could flow in freely and uncontrollably. As the consequence, the shape and size of the windows 6 would alter and stay not in accordance with the defined dimensions anymore.

It is the use of the inserts 3 described. As technically described shrinkage behavior of the material when being melted, the inserts 3 according to this application are provided

The inserts 3 can be standard transparent film, laserable and/or optical variable material. Their shape and size are freely adaptable which is in accordance with the pre-cuts of the opaque overlays 9.

The inserts 3 are not meant to change the shrinkage behavior of the material during hot lamination as it cannot be and in fact they are specifically used to fill in to the pre-cuts, eliminating the gaps and preventing the overlay and core layers 1 from being melted into to.

Therefore, the combination of using opaque overlays 9 with pre-cuts together with the inserts 3 filling techniques, it will not only be able to incorporate the transparent windows 6 into inlays 7 but also to offer an enhanced method to limit uncontrolled shrinkage and flowing behavior which cause a distortion to the windows 6 shape and size.

The present application relates to a method for bonding a plastic overlay layer, which includes a pre-punched window 6, to a plastic insert 3 positioned in the window 6. Specifically, the bonding occurs at a transitional area between the overlay layer and the insert 3, after submitting both the overlay layer and the insert 3 to a lamination process. The lamination process causes the plastic of the insert 3 and the plastic of the overlay layer to start melting, resulting in adhesion between the insert 3 and the overlay layer.

Physical absorption is an important mechanism for achieving adhesion between the surfaces of the insert 3 and the overlay layer. This mechanism involves weak attractive forces, known as van der Waals forces, operating between the adhesive and adherend. These forces are of two types: the weaker dispersion forces and the stronger polar forces. Because van der Waals forces occur between any two molecules in contact, they contribute to all adhesive bonds. To obtain good absorption, the distance between the molecules of adhesive and adherend can converge toward molecular intervals such that van der Waals interaction takes place. The lamination process provides that the adhesion occurs over a large part or the entire surface between the overlay layer and the insert 3.

Chemical bonding can also be employed to achieve higher bond strength. This involves the formation of covalent, ionic, or hydrogen bonds across the interface. The introduction of molecular bonding between the adhesive and the adherend can be obtained by reactions at the surfaces, using proper surface treatments or additional coupling agents at the surfaces between the overlay layer and the insert 3.

Diffusion is another mechanism of bonding that is specific to polymers. The lamination process provides that the molecular chains of the polymers can interpenetrate at the interface between the surfaces of the insert 3 and the overlay layer, resulting in the two surfaces becoming interlocked at a molecular level, and therefore becoming one.

Electrostatic adhesion is based on the difference in electronegativities of the adhesing materials. The adhesion forces between the adherend and adhesive layer are applied by contact or transfer potentials. These transfer potentials cause the buildup of an electric double layer at the adhesive-adherend boundary, resulting in corresponding Coulomb attraction forces between the surfaces of the insert 3 and the overlay layer.

Although chemical bonds are a significant contributor to the adhesion bond, an important force behind the adhesion is mechanical interlocking. By submitting both the insert 3 and the overlay layer to heat, they both melt such that their molten materials can penetrate into each other and then lock mechanically to the adherend after hardening. That and the increased surface at the transitional area between the two result in a mechanical bond that significantly contributes to the overall strength of the bond between the plastic overlay layer and the plastic insert 3.

In summary, the method of bonding a plastic overlay layer with a pre-punched window 6 to a plastic insert 3 involves a lamination process that melts the plastic of both components, allowing for adhesion between the surfaces of the insert 3 and the overlay layer.

Any one of the presently described embodiments can be advantageously combined with any other one.

It is suggested to combine described embodiments, or combinations thereof, with one or more of the following techniques or technologies or concepts or ideas or paradigms or states or the like:

Embodiments not shown here provide a method that builds upon FIG. 3 or 4, incorporating optical variable material (O.V.M) in the insert 3 and core layer 1 to provide a security feature, and using high-opaque material in the first and second overlay layers 10 to cover the visibility of the electronic component.

The O.V.M exhibits unique characteristics such as color shift, UV strong fluorescence, or holographic or diffractive patterns. The electronic component comprises a contactless chip module 4 and an embedded antenna 5 integrated into the core layer 1 using wire embedding.

Other embodiments have an inlay 7 for a card or document that features a core layer 1 with a first and second side, configured to accommodate an electronic component. A first overlay layer with at least one pre-fabricated window 6 is placed on the first side of the core layer 1, while a second overlay layer with at least one pre-fabricated window 6 is placed on the second side. A first insert 3 is arranged within the window 6 of the first overlay layer, preventing distortion during lamination. The electronic component is integrated within the core layer 1. In a transitional region between the first insert 3 and the first overlay layer, the materials interlace, providing an adhesive bond between the first insert 3 and the first overlay layer.

Other embodiments have an inlay 7 which includes a second overlay layer with at least one pre-punched window 6 on the second side of the core layer 1. A second insert 3 is arranged within the window 6 of the second overlay layer to prevent distortion during lamination. In a transitional region between the second insert 3 and the second overlay layer, the materials interlace to create an adhesive bond between them.

In further embodiments, at least one of the core layer 1, the first overlay layer, or the second overlay layer has varying levels of transparency or opacity, especially
where the substrate of the core layer 1 is made of a PC film, a PVC film, or a PETG film.

Either the first overlay layer, the second overlay layer, or both can be composed of a PC film, a PVC film, or a PETG film, and also the insert 3 can be made of a PC film, a PVC film, or a PETG film.

The insert 3 can include an optical variable material (O.V.M) that provides a security feature and also the inlay 7 and the core layer 1 can include a optical variable material (O.V.M) designed to provide a security feature.

The first and second opaque overlay layers 10 can be made of high-opaque material to conceal the electronic component. Transparent inserts 3 can be made from an optical variable material (O.V.M) that provides unique characteristics such as color shift, UV strong fluorescence, and additional security features. The optical variable material (O.V.M) can also include a holographic or diffractive pattern.

In other embodiments, the electronic component can comprise a chip module 4 and an embedded antenna 5, wherein the chip module 4 can be a contactless chip module 4.

The inlay 7 can have an embedded antenna 5 is integrated into the core layer 1 using wire embedding.

The above embodiments in the application can also be described using the following Itemized lists.

The first itemized list refers to the aspect relating to the multilayered inlay composition and features. The items of the first itemized list can be combined with one or more items of all other itemized lists in this document as well as with one or more features of the claims.

### First Itemized List

1. A multilayered inlay, comprising:
a plurality of layers arranged in any combination and permutation of:
a first and a second overlay layer, wherein the first and second layer having at least one pre-fabricated window;
at least one core layer placed between the first and second overlay layer, and
a plurality of inserts arranged within the pre-fabricated window of the first and second overlay layer, wherein the insert is configured to prevent distortion of the window during lamination.
2. The multilayered inlay according to item 1, wherein
the first and the second overlay layer comprise optical variable materials, for example so called OVM-layer, or white/opaque layers; and wherein
the core layer comprises a transparent core layer or two or more transparent core layers or an OVM-layer or two or more OVM-layers; and wherein
the inserts comprise OVM, and wherein
the arrangement of said layers and inserts is configured to provide enhanced security features, visual effects, or electronic functionality, and wherein
each layer and insert are bonded using a lamination process that maintains the integrity and alignment of each layer and insert despite the differing material properties.

The second itemized list refers to the aspect relating to the method for assembling multi-layer inlays with embedded inserts. The items of the second itemized list can be combined with one or more items of all other itemized lists in this document as well as with one or more features of the claims.

### Second Itemized List

1. A method for assembling a multi-layer inlay with embedded inserts, comprising:
Providing a first and second overlay layer having at least one pre-fabricated window;
Utilizing a pick-and-place machine to position inserts within said pre-fabricated window;
Employing a microbonding technique to bond the positioned inserts within the pre-fabricated window.
2. The method according to item 1, herein the microbonding involves applying localized heat and pressure to create a bond without damaging the surrounding materials or the inserts; and wherein each insert comprises optical variable materials.

The third itemized list refers to the aspect relating to the configuration and features of multi-layered inlays with electronic modules. The items of the third itemized list can be combined with one or more items of all other itemized lists in this document as well as with one or more features of the claims.

### Third Itemized List

1. A multi-layered inlay comprising:
at least one first overlay layer, the first overlay layer having at least one pre-fabricated window;
at least a first insert within the pre-fabricated window of the first overlay layer, wherein the insert is configured to prevent distortion of the window during lamination;
traces and/or wires for connecting electronic modules configured within a core layer, the core layer is placed next to the first overlay layer, and wherein the wires are positioned to be visible through the window or window including the insert.
   2. The multi-layered inlay according to item 1, wherein the visibility of the traces or wires through the window or the window including the insert provides at least one of the following:
Enhancing the aesthetic appearance of the device;
Providing visual verification of the electronic module presence and integrity;
Acting as a security feature by incorporating specific visible patterns or configurations that are difficult to replicate without proper manufacturing capabilities.
   3. The multi-layered inlay according to any of the preceding items 1 or 2, wherein the electronic modules comprise an antenna and/or a chip module.

The fourth itemized list refers to the aspect relating to the method for bonding an insert to a first overlay layer. The items of the fourth itemized list can be combined with one or more items of all other itemized lists in this document as well as with one or more features of the claims.

### Fourth Itemized List

1. A method for bonding an insert to a first overlay layer, comprising:
Aligning the insert with at least one first overlay layer, wherein at least one of the inserts and the first overlay layer comprises a fusible material;
Applying heat and pressure to the aligned insert and first overlay layer to induce fusion between the materials of the insert and the first overlay layer (2, 10); and
Controlling the heat and pressure application to form material cohesive undercuts within the fused area of the insert and/or first overlay layer, wherein the undercuts interlock to enhance the mechanical bonding strength.
2. Method according to item 1, wherein no additional adhesive is used in the bonding process, and the bonding achieves structural integrity through the material cohesion and undercut formation.

The fifth itemized list refers to the aspect relating to the method for manufacturing a laminated device. The items of the fifth itemized list can be combined with one or more items of all other itemized lists in this document as well as with one or more features of the claims.

### Fifth Itemized List

1. A method for manufacturing a laminated device, comprising:
Performing a first lamination cycle on a multi-layer assembly comprising multiple layers bonded under heat and pressure; and
Immediately following the first lamination cycle, initiating an active cooling process.
2. The method according to item 1, further comprising:
Controlling the active cooling process to rapidly reduce the temperature of the multi-layer assembly to a predetermined level effective to stabilize the materials and solidify the bonds formed during the first lamination cycle, and
wherein the active cooling involves applying a cooling medium directly to the surfaces of the multi-layer assembly or circulating the cooling medium within a chamber containing the assembly; and
Monitoring the temperature of the multi-layer assembly during the active cooling process using temperature sensors, and adjusting the cooling rate based on real-time temperature data to prevent material distortion and enhance the structural integrity of the laminated product.

The sixth itemized list refers to the aspect relating to the method for manufacturing a chip card from an inlay sheet comprising a plurality of assembled inlays. The items of the sixth itemized list can be combined with one or more items of all other itemized lists in this document as well as with one or more features of the claims.

### Sixth Itemized List

1. A method for manufacturing a chip card from an inlay sheet comprising a plurality of assembled inlays, comprising:
Providing an inlay sheet containing a plurality of assembled inlays pre-arranged in defined card areas; and
Utilizing a punching mechanism to cut a chip card from the inlay sheet, where each defined card area corresponds to the dimensions and shape of the finished chip card.

### REFERENCE NUMERAL LIST

1 transparent core layer
1 core layers
1 transparent windows core layer
2 white/opaque layer
2 first overlay layer
2 second overlay layer
3 insert
3 inserts
4 chip module
5 embedded antenna
6 transparent window
6 transparent windows
6 window
6 windows
7 inlay
7 inlays
8 chip cards
8 cards
9 opaque overlays
9 overlays
10 overlay layers
10 first overlay layer
10 second overlay layer
11 chip
12 antenna
13 lower transparent core layer
14 upper transparent core layer, can be one or more layers
15 height adjustment transparent core layer
16 inlay sheet
17 print layer
18 transparent layer
20 transition region
50 Multilayered Inlay
60 Multilayered Inlay
100 Method
100-150 Method steps
200 Method
205-215 Method steps
300 Method
305-315 Method steps
400 Method
405-420 Method steps
500 Method
505-510 Method steps

1. An inlay (7) for a card or a document, comprising:
a first overlay layer (10), wherein the first overlay layer (2, 10) having at least one pre-fabricated window (6);
a first insert (3) arranged within the pre-fabricated window (6) of the first overlay layer (10), wherein the insert (3) is configured to prevent distortion of the window (6) during lamination;
at least one core layer (1), having a first side and a second side, placed with the first side on the first overlay layer (2, 10), wherein the core layer (1) comprises a substrate and is configured to accommodate at least one electronic component (4, 5);
a second overlay layer (2, 10), wherein the second overlay layer (2, 10) having at least one pre-fabricated window (6);
a second insert (3) arranged within the pre-fabricated window (6) of the second overlay layer (2, 10), wherein the insert (3) is configured to prevent distortion of the pre-fabricated window (6) during lamination; wherein
the second overlay layer (2, 10) is placed on the second side of the core layer (1), and wherein the first and second overlay layer (2, 10) and the core layer (1) are laminated.

2. The inlay (7) according to the preceding claim, wherein in a transitional region between the second insert (3) and the second overlay layer (10), there is interlacing between the material of the second insert (3) and the material of the second overlay layer (10) providing a hot joining between the second insert (3) and the second overlay layer (10).

3. The inlay (7) according to any of the preceding claims, wherein at least one of the core layers (1), the first overlay layer (10), or the second overlay layer (10) is transparent or opaque.

4. The inlay (7) according to any of the preceding claims, wherein the substrate of the core layer (1) comprises a PC film, a PVC film, or a PETG film.

5. The inlay (7) according to any of the preceding claims, wherein the first overlay layer (10) and/or the second overlay layer (10) comprise a PC film, a PVC film, or a PETG film.

6. The inlay (7) according to any of the preceding claims, wherein the insert (3) comprises a PC film, a PVC film, or a PETG film.

7. The inlay (7) according to any of the preceding claims, wherein the insert (3) comprises an optical variable material configured to provide a security feature.

8. The inlay (7) according to any of the preceding claims, wherein the core layer (1) comprises an optical variable material configured to provide a security feature.

9. The inlay (7) according to any of the preceding claims, wherein the first opaque overlay layer (10) and the second opaque overlay layer (10) comprise a high-opaque material configured to cover visibility of the electronic component.

10. The inlay (7) according to any of the preceding claims, wherein said transparent inserts (3) are made from an optical variable material, providing unique characteristics such as color shift, UV strong fluorescence, and other security features.

11. The inlay (7) according to claim 10, wherein said optical variable material further comprises a holographic or diffractive pattern.

12. The inlay (7) according to any of the preceding claims, wherein the core layer (1) further comprises:
a lower transparent core layer (13) being in contact with a side of the first overlay layer (2, 10);
an upper transparent core layer (14) on top of the lower transparent core layer (13), wherein the upper transparent core layer (14) comprises at least one layer; and
a height adjustment transparent core layer (15) on top of the at least one upper transparent core layer (14).

13. The inlay (7) according to any of the preceding claims, wherein the inlay (7) comprises a third layer (17) on the side of the first and second overlay layer (2, 10) opposite to the core layer (1).

14. The inlay (7) according to any of the preceding claims, wherein the inlay (7) comprises a fourth layer (18) on the side of the third layer (17) opposite to the first and second overlay layer (2, 10).

15. The inlay (7) according to any of the preceding claims, wherein the electronic component comprises a chip module (4) and an embedded antenna (5).

16. The inlay (7) according to claim 15, wherein the chip module (4) is a contactless chip module (4).

17. The inlay (7) according to any of the preceding claims, wherein the embedded antenna (5) is integrated into the core layer (1) using wire embedding, printing, or etching.

18. The inlay (7) according to any of the preceding claims, wherein the pre-fabricated windows (6) in the first and second first overlay layer (2, 10) have a minimum size of 5.0×5.0 mm with a tolerance of 10% to ensure compliance with specified security feature dimensions.

19. The inlay (7) according to any of the preceding claims, wherein each pre-fabricated window (6) in the first and second first overlay layer (2, 10) includes corners with a minimum radius greater than 0.2 mm to reduce stress concentrations and enhance the structural integrity of the inlays.

20. The inlay (7) according to any of the preceding claims, wherein any line or pole in the design of the pre-fabricated window (6) has a width greater than 2.0 mm to ensure sufficient visibility and durability of the embedded security features.

21. The inlay (7) according to any of the preceding claims, wherein the inserts (3) placed within the pre-fabricated windows (6) have a thickness on one side of at least 30 μm, and preferably 50 μm, to match the opacity requirements of the first and second overlay layer (2, 10), thereby ensuring consistent visual quality and security standard compliance.

22. The inlay (7) according to any of the preceding claims, wherein hot lamination is performed at approximately 175 °C for 15 minutes to achieve optimal adhesion and integration of the layers without compromising the material integrity of the inlays.

23. A chip card with an inlay (7) according to one of the claims 1 to 22.

24. A method (100) for assembling an inlay (7), comprising the steps of:
Providing (105) a first overlay layer (2, 10), wherein the first overlay layer (2, 10) having at least one pre-fabricated window (6);
Arranging (110) a first insert (3) within the pre-fabricated window (6) of the first overlay layer (10), wherein the insert (3) is configured to prevent distortion of the window (6) during lamination;
Placing (115) a core layer (1), having a first side and a second side, with the first side on the first overlay layer (2, 10), wherein the core layer (1) comprises a substrate and is configured to accommodate at least one electronic component (4, 5);
Providing (120) a second overlay layer (2, 10), wherein the second overlay layer (2, 10) having at least one pre-fabricated window (6);
Arranging (125) a second insert (3) within the pre-fabricated window (6) of the second overlay layer (2, 10), wherein the insert (3) is configured to prevent distortion of the pre-fabricated window (6) during lamination;
Placing (130) the second overlay layer (2, 10) on the second side of the core layer (1), and
Laminating (135) the first and second overlay layer (2, 10) and the core layer (1) to assemble the inlay (7).

25. The method (100) according to claim 24, wherein the method further comprises:
Integrating (140) an electronic component within the core layer (1), wherein in a transitional region between the first insert (3) and the first overlay layer (2, 10), there is interlacing between the material of the first insert (3) and the material of the first overlay layer (2, 10), providing a hot joining between the first insert (3) and the first overlay layer (2, 10), by submitting both the insert (3) and the overlay layer (2, 10) to heat such that they both melt and their molten materials penetrate into each other and then lock mechanically to each other after hardening, without adding additional glue materials into the joint between the insert (3) and the first overlay layer (2, 10).

26. The method according to any of the proceeding claims, wherein the step of placing (115) a core layer (1) further comprises:
Placing a lower transparent core layer (13) being in contact with a side of the first overlay layer (2, 10);
Placing a upper transparent core layer (14) on top of the lower transparent core layer (13), wherein the upper transparent core layer (14) consist of at least one layer; and
Placing a height adjustment transparent core layer (15) on top of the at least one upper transparent core layer (14).

27. The method (100) according to any of the preceding claims, wherein the method further comprises:
Printing (145) a third layer (17) on the side of the first and second overlay layer (2, 10) opposite to the core layer (1).

28. The method (100) according to claim 27, wherein the method further comprises:
Printing (150) a fourth layer (18) on the side of the third layer (17) opposite to the first and second overlay layer (2, 10).

29. The method (100) according to claim 28, wherein the method further comprises:
Laminating (155) the Inlay and the third layer (17) and fourth layer (18) to assemble the inlay (7).

30. The method (100) according to any of the preceding claims, wherein the laminating step (135, 155) includes applying heat sufficient to achieve thermal bonding between the layers and active cooling under pressure to stabilize the bonded structure.

31. The method (100) according to any of the preceding claims, wherein the method step of arranging (110) of the first and second insert (3) within the pre-fabricated window (6) includes employing ultrasonic welding to bond the inserts (3) to the first and second overlay layer (2, 10) at the predetermined windows (6) to maintain alignment and positioning of the inserts (3).

32. The method (100) according to any of the preceding claims, wherein in a transitional region between the second insert (3) and the second overlay layer (2, 10), there is interlacing between the material of the second insert (3) and the material of the second overlay layer (2, 10), providing a hot joining between the second insert (3) and the second overlay layer (2, 10), by submitting both the insert (3) and the overlay layer (2, 10) to heat such that they both melt and their molten materials penetrate into each other and then lock mechanically to each other after hardening, without adding additional glue materials into the joint between the insert (3) and the second overlay layer (2, 10).

33. The method (100) according to any of the preceding claims, wherein:
the insert (3) comprises an optical variable material configured to provide a security feature, and/or
the core layer (1) comprises an optical variable material configured to provide a security feature, and/or
the core layer (1) comprises materials selected from a group consisting of polycarbonate (PC), polyvinyl chloride (PVC), and polyethylene terephthalate glycol-modified (PETG);
the first overlay layer (2, 10) and the second overlay layer (2, 10) comprise a high-opaque material configured to cover visibility of the electronic component, and/or
wherein the optical variable material, OMV, providing unique characteristics such as color shift, UV strong fluorescence, or a holographic or diffractive pattern, and/or
wherein the electronic component comprises a chip module (4) in the form of a contactless chip module (4) and an embedded antenna (5) that is integrated into the core layer (1) using wire embedding.

34. The method (100) according to any of the preceding claims, wherein the pre-fabricated windows (6) in the first and second first overlay layer (2, 10) have a minimum size of 5.0×5.0 mm with a tolerance of 10% to ensure compliance with specified security feature dimensions.

35. The method (100) according to any of the preceding claims, wherein each pre-fabricated window (6) in the first and second first overlay layer (2, 10) includes corners with a minimum radius greater than 0.2 mm to reduce stress concentrations and enhance the structural integrity of the inlays.

36. The method (100) according to any of the preceding claims, wherein any line or pole in the design of the pre-fabricated window (6) has a width greater than 2.0 mm to ensure sufficient visibility and durability of the embedded security features.

37. The method (100) according to any of the preceding claims, wherein the inserts (3) placed within the pre-fabricated windows (6) have a thickness on one side of at least 30 μm, and preferably 50 μm, to match the opacity requirements of the first and second overlay layer (2, 10), thereby ensuring consistent visual quality and security standard compliance.

38. The method (100) according to any of the preceding claims, wherein hot lamination is performed at approximately 175 °C for 15 minutes to achieve optimal adhesion and integration of the layers without compromising the material integrity of the inlays.

39. The method (100) according to any of the preceding claims, wherein the inlay (7) is assembled in an inlay sheet (16) consist of a plurality of single inlays (7), wherein the method further comprises:
extracting a single inlay (7) from the inlay sheet (16) by using cutting technique.
